(19) United States
(12) Patent Application Publication
(10) Pub. No.: US 2025/0266883 A1
(43) Pub. Date: Aug. 21, 2025

(54) METHOD AND APPARATUS FOR CHANNEL STATE INFORMATION PRE-ACQUISITION

(71) Applicant: Samsung Electronics Co., Ltd., Suwon-si (KR)

(72) Inventors: Deokhui LEE, Suwon-si (KR); Dongmyung KIM, Suwon-si (KR); Sunhyun KIM, Suwon-si (KR); Wonjun KIM, Suwon-si (KR); Hoyoung YOON, Suwon-si (KR)

(21) Appl. No.: 19/054,102

(22) Filed: Feb. 14, 2025

(30) Foreign Application Priority Data
Feb. 16, 2024 (KR) 10-2024-0022494

(51) Int. Cl. H04B 7/06; H04W 24/10

(52) U.S. Cl. CPC H04B 7/0626; H04B 7/0632; H04W 24/10

(57) ABSTRACT

The disclosure relates to a 5th generation (5G) or 6th generation (6G) communication system for supporting a higher data transfer rate than a 4th generation (4G) communication system such as long-term evolution (LTE). A method performed by a terminal in a communication system is provided. The method includes receiving, from a base station related to a source cell, a radio resource control (RRC) reconfiguration message including an L1/L2-triggered mobility (LTM) candidate configuration related to a target cell, receiving, from the base station related to the source cell, a cell switch command message instructing a cell switch to the target cell, and transmitting, to a base station related to the target cell, a cell switch completion message, wherein the LTM candidate configuration includes channel state information (CSI) configuration information related to the target cell.

### CROSS-REFERENCE TO RELATED APPLICATION(S)

This application is based on and claims priority under 35 U.S.C. § 119(a) of a Korean patent application number 10-2024-0022494, filed on Feb. 16, 2024, in the Korean Intellectual Property Office, the disclosure of which is incorporated by reference herein in its entirety.

### BACKGROUND

### 1. Field

The disclosure relates to a method and apparatus for channel state information (CSI) pre-acquisition.

### 2. Description of Related Art

Looking back at the development of wireless communication from generation to generation, technologies have been developed mainly for human-targeted services such as a voice call, a multimedia service, and a data service. After the commercialization of the 5th-generation (5G) communication system, it is expected that connected devices, which are increasing explosively, will be connected to the communication network. As examples of things connected to the network, there may be vehicles, robots, drones, home appliances, displays, smart sensors installed in various infrastructures, construction machines, and factory equipment. Mobile devices are expected to evolve into various form-factors such as augmented reality glasses, virtual reality headsets, and holographic devices. In the 6th-generation (6G) era, there have been ongoing efforts to develop an improved 6G communication system in order to connect hundreds of billions of devices and things and provide a variety of services. For these reasons, the 6G communication system is called the Beyond 5G system.

The 6G communication system, which is expected to be commercialized around 2030, will have a peak data rate of tera (i.e., 1,000 giga)-level bps and a radio latency less than 100 microseconds (usec). That is, in the 6G communication system, the data rate will be 50 times faster than that of the 5G communication systems, and the radio latency will be reduced to one-tenth.

In order to accomplish such a high data rate and an ultra-low latency, it has been considered to implement 6G communication systems in a terahertz band (e.g., 95 GHz to 3 THz bands). It is expected that, due to severer path loss and atmospheric absorption in the terahertz bands than those in the millimeter wave (mmWave) bands introduced in 5G, technologies capable of securing the signal transmission distance (i.e., coverage) will become more crucial. It is necessary to develop, as major technologies for securing the coverage, radio frequency (RF) elements, antennas, new waveforms having a better coverage than orthogonal frequency division multiplexing (OFDM), beamforming, and multi-antenna transmission technologies such as massive multiple-input multiple-output (MIMO), full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems, a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for CSI pre-acquisition and a method for L1/L2-triggered mobility (LTM) cell switch capable of fast link adaptation based thereon.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes receiving, from a base station related to a source cell, a radio resource control (RRC) reconfiguration message including an L1/L2-triggered mobility (LTM) candidate configuration related to a target cell, receiving, from the base station related to the source cell, a cell switch command message instructing a cell switch to the target cell, and transmitting, to a base station related to the target cell, a cell switch completion message, wherein the LTM candidate configuration includes channel state information (CSI) configuration information related to the target cell, wherein the CSI configuration information related to the target cell includes channel state information reference signal (CSI-RS) resource configuration related to the target cell, and CSI report configuration related to the target cell, and wherein the cell switch completion message includes CSI for the target cell based on the CSI configuration information related to the target cell.

In accordance with another aspect of the disclosure, a method performed by a base station related to a source cell in a communication system is provided. The method includes receiving, from a base station related to a target cell, channel state information (CSI) configuration information related to the target cell, transmitting, to a terminal, a radio resource control (RRC) reconfiguration message including an L1/L2-triggered mobility (LTM) candidate configuration, and transmitting, to the terminal, a cell switch command message instructing a cell switch to the target cell, wherein the LTM candidate configuration includes the CSI configuration information related to the target cell, wherein the CSI configuration information related to the target cell includes channel state information reference signal (CSI-RS) resource configuration related to the target cell, and CSI report configuration related to the target cell, and wherein a cell switch completion message includes CSI for the target cell based on the CSI configuration information related to the target cell.

In accordance with another aspect of the disclosure, a method performed by a base station related to a target cell in a communication system is provided. The method includes transmitting, to a base station related to a source cell, channel state information (CSI) configuration information related to the target cell, and receiving, from a terminal, a cell switch completion message, wherein the CSI configuration information related to the target cell includes channel state information reference signal (CSI-RS) resource configuration related to the target cell, and CSI report configuration related to the target cell, and wherein a cell switch completion message includes CSI for the target cell based on the CSI configuration information related to the target cell.

In accordance with another aspect of the disclosure, a terminal in a communication system is provided. The terminal includes a transceiver, memory storing one or more computer programs, and one or more processors communicatively to the transceiver and the memory, wherein the one or more programs include computer-executable instructions that, when executed by the one or more processors individually or collectively, cause the terminal to receive, from a base station related to a source cell, a radio resource control (RRC) reconfiguration message including an L1/L2-triggered mobility (LTM) candidate configuration related to a target cell, receive, from the base station related to the source cell, a cell switch command message instructing a cell switch to the target cell, and transmit, to a base station related to the target cell, a cell switch completion message, wherein the LTM candidate configuration includes channel state information (CSI) configuration information related to the target cell, wherein the CSI configuration information related to the target cell includes channel state information reference signal (CSI-RS) resource configuration related to the target cell, and CSI report configuration related to the target cell, and wherein the cell switch completion message includes CSI for the target cell based on the CSI configuration information related to the target cell.

In accordance with another aspect of the disclosure, a base station related to a source cell in a communication system is provided. The base station related to the source cell includes a transceiver, memory storing one or more computer programs, and one or more processors communicatively coupled to the transceiver and the memory. The one or more programs include computer-executable instructions that, when executed by the one or more processors individually or collectively, cause the base station related to the source cell to receive, from a base station related to a target cell, channel state information (CSI) configuration information related to the target cell, transmit, to a terminal, a radio resource control (RRC) reconfiguration message including an L1/L2-triggered mobility (LTM) candidate configuration, and transmit, to the terminal, a cell switch command message instructing a cell switch to the target cell, wherein the LTM candidate configuration includes the CSI configuration information related to the target cell, wherein the CSI configuration information related to the target cell includes channel state information reference signal (CSI-RS) resource configuration related to the target cell, and CSI report configuration related to the target cell, and wherein a cell switch completion message includes CSI for the target cell based on the CSI configuration information related to the target cell.

In accordance with another aspect of the disclosure, a base station related to a target cell in a communication system is provided. The base station related to the target cell includes a transceiver, memory storing one or more computer programs, and one or more processors communicatively coupled to the transceiver and the memory. The one or more programs include computer-executable instructions that, when executed by the one or more processors individually or collectively, cause the base station related to the target cell to transmit, to a base station related to a source cell, channel state information (CSI) configuration information related to the target cell, and receive, from a terminal, a cell switch completion message, wherein the CSI configuration information related to the target cell includes channel state information reference signal (CSI-RS) resource configuration related to the target cell, and CSI report configuration related to the target cell, and wherein a cell switch completion message includes CSI for the target cell based on the CSI configuration information related to the target cell.

In accordance with another aspect of the disclosure, one or more non-transitory computer-readable storage media storing one or more programs including computer-executable instructions that, when executed by one or more processors of a terminal individually or collectively, cause the terminal to perform operations is provided. The operations include receiving, from a base station related to a source cell, a radio resource control (RRC) reconfiguration message including an L1/L2-triggered mobility (LTM) candidate configuration related to a target cell, receiving, from the base station related to the source cell, a cell switch command message instructing a cell switch to the target cell, and transmitting, to a base station related to the target cell, a cell switch completion message, wherein the LTM candidate configuration includes channel state information (CSI) configuration information related to the target cell, wherein the CSI configuration information related to the target cell includes channel state information reference signal (CSI-RS) resource configuration related to the target cell, and CSI report configuration related to the target cell, and wherein the cell switch completion message includes CSI for the target cell based on the CSI configuration information related to the target cell.

According to various embodiments of the disclosure, the terminal can pre-acquire CSI for a target cell before completing a cell switch and transfer the CSI to the target cell immediately after completing the cell switch, thereby minimizing throughput degradation due to a robust link adaptation scheme.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of an LTE system according to an embodiment of the disclosure;

FIG. 2 is a diagram illustrating a radio protocol structure of an LTE system according to an embodiment of the disclosure;

FIG. 3 is a diagram illustrating a structure of a next-generation mobile communication system according to an embodiment of the disclosure;

FIG. 4 is a diagram illustrating a radio protocol structure of a next-generation mobile communication system according to an embodiment of the disclosure;

FIG. 5 illustrates a signal flow for a random access (RA) procedure according to an embodiment of the disclosure;

FIG. 6 illustrates a signal flow for UE capability information reporting from a UE to a base station according to an embodiment of the disclosure;

FIG. 7 is a diagram illustrating a process of performing a general handover operation in a mobile communication system according to an embodiment of the disclosure;

FIG. 8 is a diagram illustrating an example of an interruption time occurring in a handover process according to an embodiment of the disclosure;

FIG. 9 is a diagram illustrating operations of a UE and a base station performing an LTM-based cell switch according to an embodiment of the disclosure;

FIG. 10 is a diagram illustrating an early synchronization procedure according to an embodiment of the disclosure;

FIG. 11 is a diagram illustrating a relationship between a cell switch completion time and a CSI reporting time according to an embodiment of the disclosure;

FIG. 12 is a diagram illustrating an LTM cell switch procedure supporting fast link adaptation according to an embodiment of the disclosure;

FIG. 13 is a diagram illustrating operations of a UE according to an embodiment of the disclosure;

FIG. 14 is a diagram illustrating operations of a base station associated with a source cell according to an embodiment of the disclosure;

FIG. 15 is a diagram illustrating operations of a base station associated with a target cell according to an embodiment of the disclosure;

FIG. 16 is a diagram illustrating an MCS level change according to a link adaptation operation and an MCS level change according to a link adaptation operation in a technology according to an embodiment of the disclosure;

FIG. 17 is a block diagram illustrating an example of components of a UE according to an embodiment of the disclosure; and

FIG. 18 is a block diagram illustrating an example of components of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operations to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “unit”, as used herein, refers to a software or hardware component or device, such as a field programmable gate array (FPGA) or application specific integrated circuit (ASIC), which performs certain tasks. However, “unit” is not limited to software or hardware. A “unit” may be configured to reside on an addressable storage medium and configured to execute on one or more processors. Thus, a module or “unit” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “units” may be combined into fewer components and “units” or further separated into additional components and “units”. In addition, the components and “units” may be implemented to operate one or more central processing units (CPUs) in a device or a secure multimedia card. Also, in embodiments, the “unit” may include one or more processors.

In the following description of the disclosure, a detailed description of known functions, components, or configurations incorporated herein will be omitted when it may make the subject matter of the disclosure unnecessarily unclear.

In the following description, terms for identifying access nodes, terms referring to network entities, terms referring to messages, terms referring to interfaces between network entities, terms referring to various types of identification information, and the like are illustratively used for the sake of convenience. Therefore, the disclosure is not limited by the terms as used below, and other terms referring to subjects having equivalent technical meanings may be used.

In the following description, the terms physical channel and signal may be used interchangeably with data or a control signal. For example, a physical downlink shared channel (PDSCH) is a term referring to a physical channel through which data is transmitted, but PDSCH may also be used to refer to data. That is, in the disclosure, the expression “transmitting a physical channel” may be interpreted equivalently to the expression “transmitting data or a signal through a physical channel”.

In the disclosure, upper or higher signaling refers to a signal transmission method in which a base station transmits a signal to a terminal via a downlink data channel of a physical layer, or a terminal transmits a signal to a base station via an uplink data channel of a physical layer. Upper or higher signaling can be understood as radio resource control (RRC) signaling or a media access control (MAC) control element (CE).

In the disclosure, terms and names defined in the 3rd generation partnership project long term evolution (3GPP LTE) standards are used for the convenience of description. However, the disclosure is not limited by these terms and names, and may be applied equally to systems that conform other standards.

In the disclosure, a base station refers to an entity performing resource allocation of a terminal, and may be at least one of a gNode B (gNB), an eNode B (eNB), a Node B, a base station (BS), a radio access unit, a base station controller, or a node on a network. In addition, a terminal may include, but is not limited to, a user equipment (UE), a mobile station (MS), a cellular phone, a smart phone, a computer, an Internet of thing (IoT) device, a sensor, a wireless communication device, or a multimedia system capable of performing a communication function.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

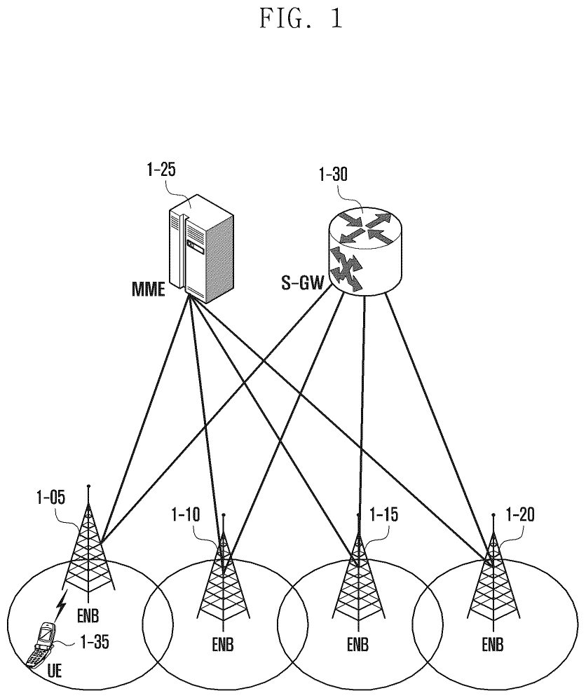

FIG. 1 is a diagram illustrating a structure of an LTE system according to an embodiment of the disclosure.

Referring to FIG. 1, a radio access network of the LTE system may include next-generation base stations (evolved Node Bs, hereinafter referred to as eNBs, Node Bs, or base stations) 1-05, 1-10, 1-15 and 1-20, a mobility management entity (MME) 1-25, and a serving-gateway (S-GW) 1-30. A user equipment 1-35 (hereinafter referred to as a UE or a terminal) may access an external network through the eNBs 1-05 to 1-20 and the S-GW 1-30.

Referring to FIG. 1, the eNBs 1-05 to 1-20 may correspond to conventional Node Bs of a universal mobile telecommunications system (UTMS). The eNB is connected to the UE 1-35 through a radio channel and may perform a more complicated role than the conventional node B. In the LTE system, all user traffic including a real time service such as a voice over IP (VOIP) through an Internet protocol can be serviced through a shared channel. Therefore, an apparatus for collecting state information on buffer states, available transmit power states, channel states, etc. of UEs and performing scheduling is required, and the eNBs 1-05 to 1-20 may serve as this apparatus. In general, one eNB may control a plurality of cells. For example, in order to implement a transfer rate of 100 Mbps, the LTE system may use orthogonal frequency division multiplexing (OFDM) as a radio access technology in a bandwidth of 20 MHz. Furthermore, an adaptive modulation and coding (AMC) scheme of determining a modulation scheme and a channel coding rate may be applied depending on the channel state of the UE. The S-GW 1-30 is an apparatus for providing a data bearer and may generate or remove the data bearer under the control of the MME 1-25. The MME is an apparatus for performing not only a mobility management function for the UE but also various control functions and may be connected to the plurality of eNBs 1-05 to 1-20.

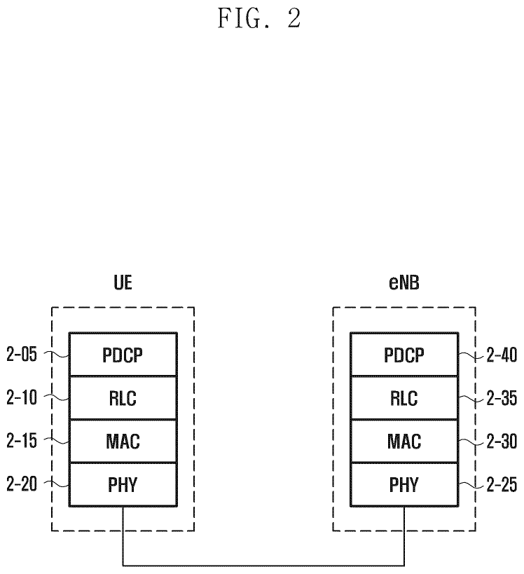

FIG. 2 is a diagram illustrating a radio protocol structure of an LTE system according to an embodiment of the disclosure.

Referring to FIG. 2, the UE and the eNB may include packet data convergence protocols (PDCPs) 2-05 and 2-40, radio link controls (RLCs) 2-10 and 2-35, medium access controls (MACs) 2-15 and 2-30, respectively, in the radio protocol of the LTE system. The PDCPs 2-05 and 2-40 may perform operations such as IP header compression/decompression. The main functions of the PDCPs 2-05 and 2-40 can be summarized as follows.
Header compression and decompression function (Header compression and decompression: ROHC only).
User data transmission function (Transfer of user data).
Sequential delivery function (In-sequence delivery of upper layer PDUs at PDCP re-establishment procedure for RLC AM).
Reordering function (For split bearers in DC (only support for RLC AM): PDCP PDU routing for transmission and PDCP PDU reordering for reception).
Duplicate detection function (Duplicate detection of lower layer SDUs at PDCP re-establishment procedure for RLC AM).
Retransmission function (Retransmission of PDCP SDUs at handover and, for split bearers in DC, of PDCP PDUs at PDCP data-recovery procedure, for RLC AM).
Ciphering and deciphering function (Ciphering and deciphering).
Timer-based SDU removal function (Timer-based SDU discard in uplink).
The RLCs 2-10 or 2-35 may reconstruct a PDCP packet data unit (PDU) to an appropriate size and perform an automatic repeat request (ARQ) operation or the like. The main functions of the RLCs 2-10 and 2-35 can be summarized as follows.
Data transmission function (Transfer of upper layer PDUs).
ARQ function (Error correction through ARQ (only for AM data transfer)).
Concatenation, segmentation, and reassembly function (Concatenation, segmentation and reassembly of RLC SDUs (only for UM and AM data transfer)).
Re-segmentation function (Re-segmentation of RLC data PDUs (only for AM data transfer)).
Reordering function (Reordering of RLC data PDUs (only for UM and AM data transfer)).
Duplication detection function (Duplicate detection (only for UM and AM data transfer)).
Error detection function (Protocol error detection (only for AM data transfer)).
RLC SDU deletion function (RLC SDU discard (only for UM and AM data transfer)).
RLC re-establishment function (RLC re-establishment).

The MACs 2-15 and 2-30 are connected with various RLC layer devices composed in one UE and may perform operations of multiplexing RLC PDUs to MAC PDU and de-multiplexing RLC PDUs from MAC PDU. The main functions of the MACs 2-15 and 2-30 can be summarized as follows.
Mapping function (Mapping between logical channels and transport channels).
Multiplexing and demultiplexing function (Multiplexing/demultiplexing of MAC SDUs belonging to one or multiple different logical channels into/from transport blocks (TB) delivered to/from the physical layer on transport channels).
Scheduling information reporting function (scheduling information reporting).
Hybrid automatic repeat request (HARQ) function (Error correction through HARQ).
Logical channel priority control function (Priority handling between logical channels of one UE).
UE priority control function (Priority handling between UEs by means of dynamic scheduling).
MBMS service identification function (MBMS service identification).
Transport format selection function (Transport format selection).
Padding function (Padding).

The PHY layers 2-20 and 2-25 may perform operations of channel-coding and modulating higher layer data to generate an OFDM symbol and transmitting it through a radio channel or demodulating and channel-decoding an OFDM symbol received through a radio channel and transmitting it to a higher layer.

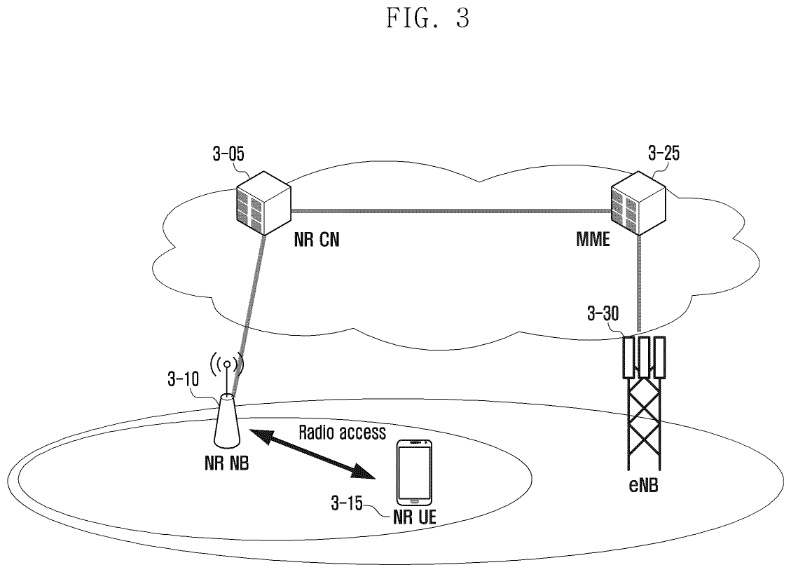

FIG. 3 is a diagram illustrating a structure of a next-generation mobile communication system according to an embodiment of the disclosure.

Referring to FIG. 3, a radio access network of the next-generation mobile communication system (hereinafter referred to as NR or 5G) may include a new radio node B (NR NB) 3-10 (hereinafter referred to as an NR gNB or an NR base station) and a new radio core network (NR CN) 3-05. A new radio user equipment (NR UE) 3-15 (hereinafter referred to as an NR UE or a terminal) may access an external network through the NR gNB 3-10 and the NR CN 3-05.

Referring to FIG. 3, the NR gNB 3-10 may correspond to an evolved Node B (eNB) in a conventional LTE system. The NR gNB 3-10 is connected to the NR UE 3-15 through a radio channel and may provide better service than the conventional node B. In the next-generation mobile communication system, all user traffic can be serviced through a shared channel. Therefore, an apparatus for collecting state information on buffer states, available transmit power states, channel states, etc. of UEs and performing scheduling is required, and the NR NB 3-10 may serve as this apparatus. One NR gNB may control a plurality of cells. In the next-generation mobile communication system, a bandwidth greater than the existing maximum bandwidth can be applied in order to implement super-high-speed data transmission compared to conventional LTE. In addition, orthogonal frequency division multiplexing (OFDM) is used as a radio access technology, and a beamforming technology can be further applied. Furthermore, an adaptive modulation and coding (AMC) scheme of determining a modulation scheme and a channel coding rate may be applied depending on the channel state of the UE. The NR CN 3-05 may perform functions such as mobility support, bearer configuration, and quality of service (QOS) configuration. The NR CN 3-05 is an apparatus for performing not only a mobility management function for the UE but also various control functions and may be connected to a plurality of base stations. Further, the next-generation mobile communication system may be linked to the conventional LTE system, and the NR CN 3-05 may be connected to an MME 3-25 through a network interface. The MME 3-25 may be connected to an eNB 3-30, which is a conventional base station.

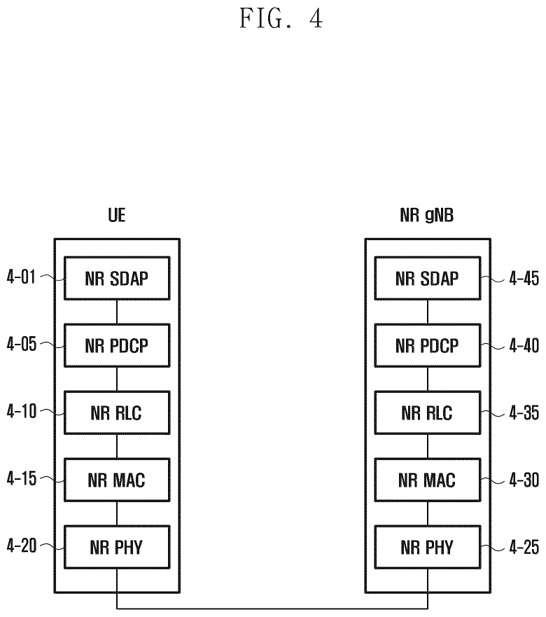

FIG. 4 is a diagram illustrating a radio protocol structure of a next-generation mobile communication system according to an embodiment of the disclosure.

Referring to FIG. 4, the UE and the NR base station may include NR service data adaptation protocols (SDAPs) 4-01 and 4-45, NR PDCPs 4-05 and 4-40, NR RLCs 4-10 and 4-35, and NR MACs 4-15 and 4-30, respectively, in the radio protocol of the next-generation mobile communication system.

The main functions of the NR SDAPs 4-01 and 4-45 may include some of the following functions.
User data transmission function (Transfer of user plane data).
Function of mapping QoS flow and a data bearer for uplink and downlink (Mapping between a QoS flow and a data ratio bearer (DRB) for both DL and UL).
Function of marking a QoS flow ID for uplink and downlink (Marking QoS flow ID in both DL and UL packets).
Function of mapping reflective QoS flow to a data bearer for uplink SDAP PDUs (Reflective QoS flow to DRB mapping for the UL SDAP PDUs).

With respect to an SDAP layer device, the UE may be configured through an RRC message whether or not to use a header of the SDAP layer device or whether or not to use a function of the SDAP layer device, for each PDCP layer device, each bearer, or each logical channel. If the SDAP header is configured, a 1-bit indicator of non-access stratum (NAS) reflective QoS of the SDAP header and a 1 bit-indicator of (access stratum (AS) reflective QoS may indicate that the UE can update or reconfigure mapping information about QoS flow and a data bearer in uplink and downlink. The SDAP header may include QoS flow ID information indicating the QoS. The QoS information may be used as data processing priority, scheduling information, etc. to support a seamless service.

The main functions of the NR PDCPs 4-05 and 4-40 may include some of the following functions.
Header compression and decompression function (Header compression and decompression: ROHC only).
User data transmission function (Transfer of user data).
Sequential delivery function (In-sequence delivery of upper layer PDUs).
Non-sequential delivery function (Out-of-sequence delivery of upper layer PDUs).
Reordering function (PDCP PDU reordering for reception).
Duplicate detection function (Duplicate detection of lower layer SDUs).
Retransmission function (Retransmission of PDCP SDUs).
Ciphering and deciphering function (Ciphering and deciphering).
Timer-based SDU removal function (Timer-based SDU discard in uplink).

In the above description, the reordering function of the NR PDCP device may refer to a function of sequentially reordering PDCP PDUs received from a lower layer based on a PDCP sequence number (SN). The reordering function of the NR PDCP device may include a function of sequentially transferring the reordered data to a higher layer, a function of directly transferring the reordered data without regard to the order, a function of recording lost PDCP PDUs by reordering, a function of reporting the statuses of the lost PDCP PDUs to a transmitting side, or a function of requesting retransmission of the lost PDCP PDUs.

The main functions of the NR RLCs 4-10 and 4-35 may include some of the following functions.
Data transmission function (Transfer of upper layer PDUs).
Sequential delivery function (In-sequence delivery of upper layer PDUs).
Non-sequential delivery function (Out-of-sequence delivery of upper layer PDUs).
ARQ function (Error correction through ARQ).
Concatenation, segmentation, and reassembly function (Concatenation, segmentation and reassembly of RLC SDUs).
Re-segmentation function (Re-segmentation of RLC data PDUs).
Reordering function (Reordering of RLC data PDUs).
Duplicate detection function (Duplicate detection).
Error detection function (Protocol error detection).
RLC SDU deletion function (RLC SDU discard).
RLC re-establishment function (RLC re-establishment).

In the above description, the sequential delivery function (In-sequence delivery) of the NR RLC device may refer to a function of sequentially transferring RLC PDUs received from a lower layer to a higher layer. In the case where one original RLC SDU is divided into a plurality of RLC SDUs and received, the sequential delivery function (In-sequence delivery) of the NR RLC device may include a function of reassembling and transmitting the RLC SDUs.

The sequential delivery function (In-sequence delivery) of the NR RLC device may include a function of reordering the received RLC PDUs based on an RLC sequence number (SN) or a PDCP SN, a function of recording lost RLC PDUs by reordering, a function of reporting the statuses of the lost RLC PDUs to a transmitting side, and a function of requesting retransmission of the lost RLC PDUs.

In the case that there is a lost RLC SDU, the sequential delivery function (In-sequence delivery) of the NR RLC device may include a function of sequentially transferring only RLC SDUs preceding the lost RLC SDU to the higher layer.

If a predetermined timer expires even when there is a lost RLC SDU, the sequential delivery function (In-sequence delivery) of the NR RLC device may include a function of sequentially transferring all RLC SDUs received before the timer starts to the higher layer.

If a predetermined timer expires even when there is a lost RLC SDU, the sequential delivery function (In-sequence delivery) of the NR RLC device may include a function of sequentially transferring all RLC SDUs received up to that point in time to the higher layer.

The NR RLC device may process the RLC PDUs sequentially in the order of reception thereof regardless of the order of sequence numbers (out-of-sequence delivery) and transfer them to the NR PDCP device.

In the case of receiving a segment, the NR RLC device may use segments stored in the buffer or receive segments later, reassemble them into a complete one RLC PDU, and transmit it to the NR PDCP device.

The NR RLC layer may not include a concatenation function, and this function may be performed by the NR MAC layer or replaced with a multiplexing function of the NR MAC layer.

In the above description, the non-sequential delivery function (Out-of-sequence delivery) of the NR RLC device may refer to a function of transferring RLC SDUs received from a lower layer directly to a higher layer regardless of the order of the RLC SDUs. In the case where one original RLC SDU is divided into a plurality of RLC SDUs and received, the non-sequential delivery function (Out-of-sequence delivery) of the NR RLC device may include a function of reassembling and transmitting the RLC SDUs. The non-sequential delivery function (Out-of-sequence delivery) of the NR RLC device may include a function of storing RLC SNs or PDCP SNs of the received RLC PDUs, reordering them, and recording lost RLC PDUs.

The NR MACs 4-15 and 4-30 may be connected to a plurality of NR RLC layer devices composed in one apparatus, and main functions of the NR MACs 4-15 and 4-30 may include some of the following functions.
Mapping function (Mapping between logical channels and transport channels).
Multiplexing and demultiplexing function (Multiplexing/demultiplexing of MAC SDUs).
Scheduling information reporting function (Scheduling information reporting).
HARQ function (Error correction through HARQ).
Logical channel priority control function (Priority handling between logical channels of one UE).
UE priority control function (Priority handling between UEs by means of dynamic scheduling).
MBMS service identification function (MBMS service identification).
Transport format selection function (Transport format selection).
Padding function (Padding).

The NR PHY layers 4-20 and 4-25 may perform operations of channel-coding and modulating higher layer data to generate an OFDM symbol and transmitting it through a radio channel or demodulating and channel-decoding an OFDM symbol received through a radio channel and transmitting it to a higher layer.

In the description of the disclosure, uplink (UL) may refer to a radio link through which the UE transmits data or a control signal to the base station, and downlink (DL) may refer to a radio link through which the base station transmits data or a control signal to the UE.

In the initial access stage where the UE initially accesses the system, the UE may synchronize downlink time and frequency from a synchronization signal transmitted by the base station through a cell search, and acquire a cell identifier (cell ID). Then, using the acquired cell ID, the UE may receive a physical broadcast channel (PBCH) and acquire a master information block (MIB), which is essential system information, from the PBCH. Additionally, the UE may receive system information (system information block (SIB)) from the base station and acquire cell-common transmission/reception related control information. The cell-common transmission/reception related control information may include random access related control information, paging related control information, common control information for various physical channels, etc.

The synchronization signal is a signal that serves as a reference for cell search, and the subcarrier spacing may be applied to suit a channel environment, such as phase noise, for each frequency band. In the case of a data channel or a control channel, the subcarrier spacing may be applied differently depending on the service type in order to support various services as described above. The following components may be defined for explanation.
Primary Synchronization Signal (PSS): It is a signal that serves as a reference for DL time/frequency synchronization and provides some information about the cell ID.
Secondary Synchronization Signal (SSS): It is a signal that serves as a reference for DL time/frequency synchronization and provides some remaining information about the cell ID. Additionally, it may serve as a reference signal for demodulation of PBCH.
Physical Broadcast Channel (PBCH): It provides master information block (MIB), which is essential system information required for transmission and reception of a data channel and a control channel of the UE. The essential system information may include information such as search space related control information indicating radio resource mapping information of the control channel, scheduling control information for a separate data channel transmitting system information, and a system frame number (SFN), which is a frame unit index that serves as a timing reference.
Synchronization Signal/PBCH Block (SS/PBCH Block or SSB): The SS/PBCH block consists of N OFDM symbols and is composed of a combination of PSS, SSS, PBCH, etc. In the case of a system to which a beam sweeping technique is applied, the SS/PBCH block is the minimum unit to which beam sweeping is applied. In the 5G system, N may be 4. The base station may transmit up to L SS/PBCH blocks, and the L SS/PBCH blocks are mapped within a half frame (0.5 ms). In addition, the L SS/PBCH blocks are periodically repeated in units of a predetermined period P. The period P may be notified to the UE via signaling from the base station. If there is no separate signaling for the period P, the UE applies a pre-agreed default value.

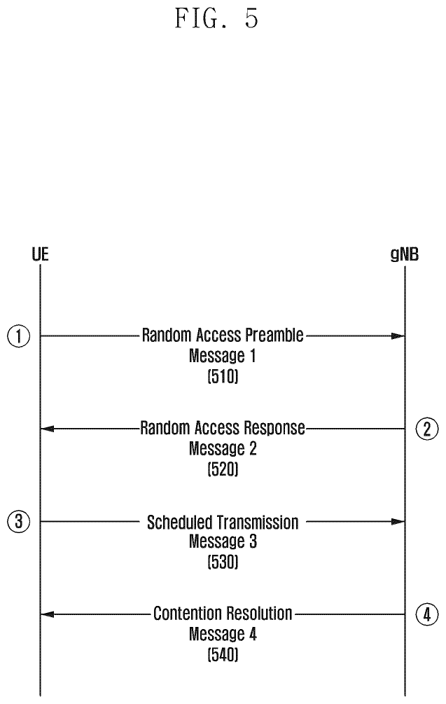

After the UE acquires MIB and system information from the base station through the initial access procedure, the UE may perform a random access procedure to switch a link with the base station to a connected state (or RRC_CONNECTED state). Upon completing the random access procedure, the UE switches to the connected state, and one-to-one communication becomes possible between the base station and the UE. The random access procedure will be described in detail with reference to FIG. 5 below.

FIG. 5 illustrates a signal flow for a random access (RA) procedure according to an embodiment of the disclosure.

Referring to FIG. 5, in operation 510, a UE may transmit a random access preamble to a base station (gNB). The random access preamble is the initial transmission message of the UE in the random access procedure and may be referred to as message 1. The base station may measure a transmission delay between the UE and the base station from the random access preamble and synchronize the uplink. At this time, the UE may arbitrarily select which random access preamble to use within a random access preamble set given by system information in advance. The initial transmission power of the random access preamble may be determined according to a path loss, measured by the UE, between the base station and the UE. In addition, the UE may determine a transmission beam direction of the random access preamble from a synchronization signal received from the base station and transmit the random access preamble.

In operation 520, the base station may transmit an uplink transmission timing adjustment command to the UE, based on the transmission delay value measured from the random access preamble received in operation 510. The base station may transmit an uplink resource and power control command to be used by the UE as scheduling information to the UE. The scheduling information transmitted by the base station may include control information for an uplink transmission beam of the UE.

If the UE fails to receive a random access response (RAR) (or message 2), which is scheduling information for message 3, from the base station within a predetermined time in operation 520, the UE may perform operation 510 again. In the case of performing operation 510 again, the UE may increase the transmission power of the random access preamble by a predetermined operation (e.g., power ramping), thereby increasing the probability of the base station receiving the random access preamble.

In operation 530, the UE may transmit uplink data (message 3) including UE ID to the base station by using the uplink resources allocated in operation 520. The UE may transmit the uplink data including the UE ID to the base station through an uplink data channel (i.e., a physical uplink shared channel (PUSCH)). The transmission timing of the uplink data channel for transmitting the message 3 may follow the timing control command received from the base station in operation 520. The transmission power of the uplink data channel for transmitting the message 3 may be determined in consideration of the power control command received from the base station in operation 520 and the power ramping value of the random access preamble. The uplink data channel for transmitting the message 3 may refer to an initial uplink data signal that the UE transmits to the base station after the UE transmits the random access preamble.

In operation 540, if the base station determines that the UE has performed random access without collision with other UEs, the base station may transmit data (message 4) including the ID of the UE that transmitted the uplink data in operation 530 to the UE. If the UE receives the signal transmitted by the base station in operation 540 from the base station, the UE may determine that the random access is successful. The UE may transmit hybrid automatic repeat request acknowledgement (HARQ-ACK) information indicating whether the message 4 has been successfully received to the base station through an uplink control channel (i.e., a physical uplink control channel (PUCCH)).

If the data transmitted by the UE in operation 530 collides with data from another UE and thereby the base station fails to receive a data signal from the UE, the base station may not transmit any more data to the UE. If the UE fails to receive data transmitted from the base station in operation 540 within a certain period of time, the UE may determine that the random access procedure has failed, and may proceed again from operation 510.

If the UE successfully completes the random access procedure, the UE switches to the connected state, and one-to-one communication may be enabled between the base station and the UE. The base station may receive UE capability information from the UE in the connected state and adjust scheduling by referring to the UE capability information of the UE. Through the UE capability information, the UE may inform the base station of whether the UE itself supports a certain function, the maximum allowable value of the function supported by the UE, etc. Therefore, the UE capability information reported by each UE to the base station may have different values for respective UEs.

For example, the UE may report the UE capability information including at least one of the following types of control information to the base station.
Control information related to a frequency band supported by the UE.
Control information related to a channel bandwidth supported by the UE.
Control information related to a maximum modulation scheme supported by the UE.
Control information related to a maximum number of beams supported by the UE.
Control information related to a maximum number of layers supported by the UE.
Control information related to CSI reporting supported by the UE.
Control information on whether the UE supports frequency hopping.
Control information related to bandwidth in the case of supporting carrier aggregation (CA).
Control information on whether cross carrier scheduling is supported in the case of supporting CA.

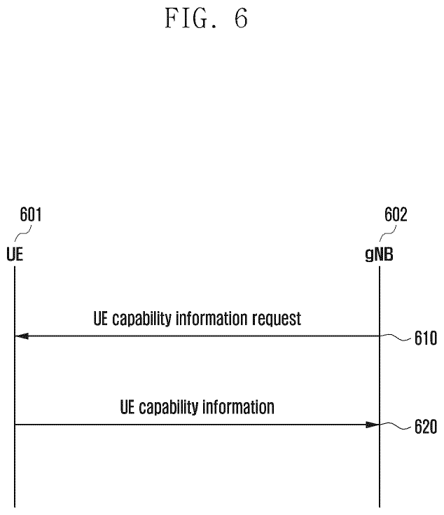

FIG. 6 illustrates a signal flow for UE capability information reporting from a UE to a base station according to an embodiment of the disclosure.

Referring to FIG. 6, in operation 610, the base station 602 may transmit a UE capability information request message to the UE 601. Based on the UE capability information request from the base station, the UE may transmit UE capability information to the base station in operation 620. According to an embodiment, the UE may transmit the UE capability information to the base station regardless of the UE capability information request from the base station. The UE capability information reported by the UE to the base station may indicate whether a UE operation according to various embodiments of the disclosure for performing the CSI pre-acquisition method and the LTM cell switch method capable of fast link adaptation based thereon is supported.

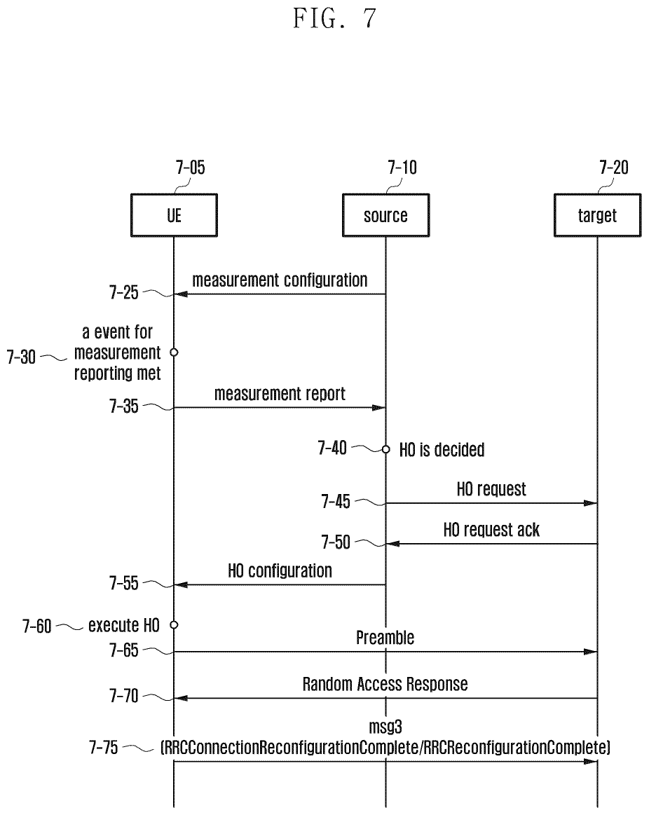

FIG. 7 is a diagram illustrating a process of performing a general handover operation in a mobile communication system according to an embodiment of the disclosure.

In the embodiment of FIG. 7, a source cell 7-10 may be named as a source base station or a source node, and a target cell 7-20 may be named as a target base station or a target node.

A UE 7-05 receives a predetermined RRC message including measurement configuration information from the source cell 7-10 in operation 7-25. The UE 7-05 measures the signal qualities of a serving cell and neighbor cells by applying the measurement configuration information, and periodically or when a configured event 7-30 occurs, reports collected cell measurement information to the source cell 7-10 in operation 7-35.

The source cell 7-10 determines whether to trigger a general handover operation based on the reported cell measurement information in operation 7-40. For example, if an event A3 (neighbor becomes offset better than SpCell) is satisfied and the cell measurement information is reported, the source cell 7-10 may determine a general handover. If it is determined to trigger the general handover, the source cell 7-10 may request a handover to one target cell 7-20 in operation 7-45. For example, the source cell 7-10 may request the general handover through a predetermined inter-node message in operation 7-45. For example, the inter-node message may be, but not limited to, a handover (HO) request message. The target cell 7-20 that receives the handover request accepts it and transmits handover configuration information necessary for the general handover operation to the source cell 7-10 in operation 7-50. The target cell 7-20 may transmit the inter-node message including the handover configuration information to the source cell 7-10. The inter-node message may be, but not limited to, a handover request response (HO request ack) message.

The source cell 7-10 inserts the handover configuration information received from the target cell 7-20 and additional configuration information in a predetermined RRC message and transmits the RRC message to the UE 7-05 in operation 7-55. For example, the RRC message may be an RRC connection reconfiguration message or an RRC reconfiguration message, and the RRC message may include a handover command. The configuration information may include at least one of a target cell ID, frequency information, configuration information (dedicated preamble information, dedicated radio resource information, etc.) required for a random access operation to the target cell, transmission power information, C-RNTI information used in the target cell, etc.

The UE 7-05 that has received the handover configuration information may start a handover operation in operation 7-60. The UE 7-05 starts the random access process to the target cell 7-20 based on the handover configuration information and starts a T304 timer in operation 7-60. At the same time, the UE 7-05 stops data transmission and reception with the serving cell 7-10. This is because the UE 7-05 has a single protocol stack. The UE 7-05 may transmit to the target cell 7-20 the preamble provided based on the configuration information required for the random access operation to the target cell in operation 7-65. If a dedicated preamble has not been provided, the UE 7-05 may transmit one of preambles used on a contention basis. The target cell 7-20 that has received the preamble transmits a random access response (RAR) message to the UE 7-05 in operation 7-70. The UE 7-05 transmits msg3 to the target cell 7-20 by using UL grant information contained in the RAR in operation 7-75. The msg3 contains an RRCConnectionReconfigurationComplete message in the case of an LTE system and an RRCReconfigurationComplete message in the case of an NR system. When the random access process is successfully completed, the UE 7-05 considers the general handover to have been successfully completed, and stops the running T304 timer. If the general handover is not successfully completed until the T304 timer expires, the UE 7-05 may consider the handover as a failure and declare a radio link failure (RLF).

In the general handover process, the cell measurement information measured by the UE and reported to the source cell is a layer-3 measurement report, and handover based on the layer-3 measurement report may result in throughput degradation before and after the handover for the following reasons.
Interruption time.
Robust link adaptation scheme.

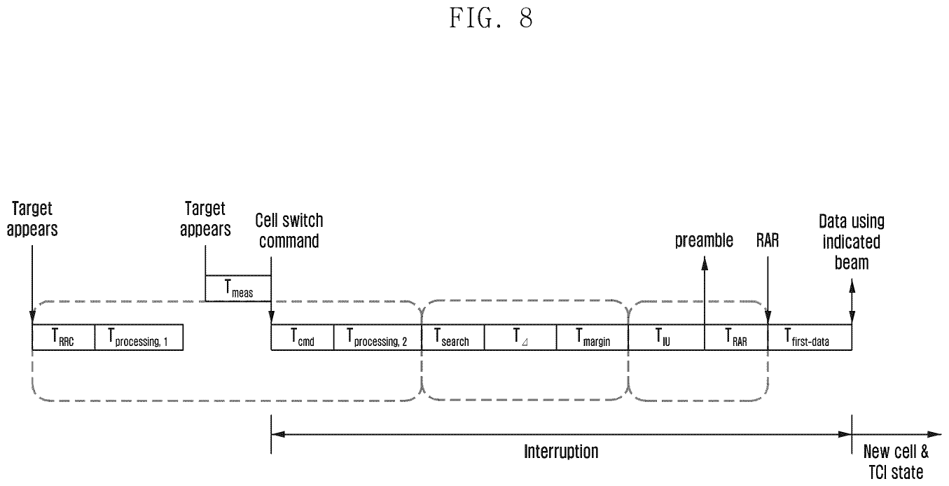

FIG. 8 is a diagram illustrating an example of an interruption time occurring in a handover process according to an embodiment of the disclosure.

The interruption time refers to an interval in which the UE cannot transmit or receive data during the handover process, and may be defined as follows.

$${T}_{interruption} = {T}_{cmd} + {T}_{processing , 2} + {T}_{s e a r c h} + {T}_{Δ} + {T}_{margin} + {T}_{I U} + {T}_{RAR} + {T}_{first - data}$$

The meaning and value of each parameter may be defined as in Table 1.

TABLE 1

| | | Value in L3 based | | Value in LTM | |
|---|---|---|---|---|---|
| Component | Meaning | mobility (Legacy) | | based mobility | |
| T_{RRC} | Processing time for | Up to [10] ms | | | |
| | RRCReconfiguration | | | | |
| | carrying candidate | | | | |
| | configurations | | | | |
| T_{processing, 1} | Time for UE processing, | Up to [20] ms for | | — | |
| | before and after cell | same FR | | | |
| T_{processing, 2} | switch command, | Up to [40] | Up to | Can be | Up |
| | respectively. This may | ms for | [66] | minimized | to |
| | include L2/3 | different | ms | by RRM | a |
| | reconfiguration, RF | FR | (if cell | (if L2/3 | few |
| | retuning, baseband | | is | config. is not | ms |
| | retuning, security update | | known | changed) | |
| | if needed, etc. | | & | | |
| | | | same | | |
| | | | FR) | | |
| Tₘₑₐₛ | Measurement delay | — | | — | |
| | (from target appears to | | | | |
| | cell switch command) | | | | |
| T_{cmd} | Time for processing | Up to [5] | | Need | |
| | L1/L2-command (HARQ | ms | | investigation | |
| | and parsing) | | | | |
| T_{search} | Time required to search | 0 ms (if | | 0 ms (always | |
| | the target cell | cell is | | cell is | |
| | | known) | | known) | |
| | | Up to [60] | | | |
| | | ms (if cell | | | |
| | | is | | | |
| | | unknown) | | | |
| T_{Δ} | Time for fine tracking | SMTC | | Can be | |
| | and acquiring full timing | periodicity | | neglected by | |
| | information | (typ. [20] | | early Sync. | |
| | | ms) | | | |
| T_{margin} | Time for SSB or CSI-RS | Up to [2] | | Can be | |
| | post-processing | ms | | neglected by | |
| | | | | early Sync. | |
| T_{IU} | interruption uncertainty | Typ. [15] | | Can be | |
| | in acquiring the first | ms | | neglected by | |
| | available PRACH | | | early Sync. | |
| | occasion in the new cell | | | | |
| T_{RAR} | Time for RAR delay | Typ. [4] | | Can be | |
| | | ms | | neglected by | |
| | | | | early Sync. | |
| T_{first-data} | Time for UE performs | — | | — | |
| | the first DL/UL | | | | |
| | reception/ transmission | | | | |
| | on the indicated beam of | | | | |
| | the target cell, after RAR | | | | |

Referring to FIG. 8 and Table 1, in the typical handover process, time is required for downlink (DL) synchronization and uplink (UL) synchronization, and this time for DL synchronization and UL synchronization constitutes the interruption time in which throughput is reduced. In order to minimize the interruption time in which the UE cannot transmit and receive data, L1/L2-triggered mobility (LTM), which is a beam level cell switch technology, is currently under discussion.

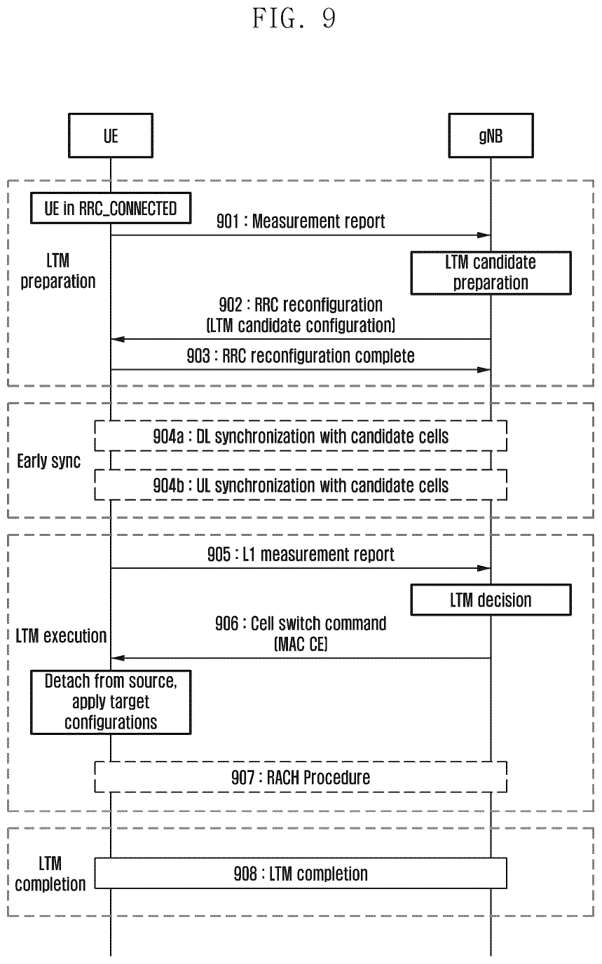

FIG. 9 is a diagram illustrating operations of a UE and a base station performing an LTM-based cell switch according to an embodiment of the disclosure.

Hereinafter, in describing the disclosure, any procedure for switching a serving cell of the UE, including a handover that switches a serving base station of the UE from a source base station to a target base station, is collectively referred to as a cell switch. The following description about the ‘cell switch’ may also be applied to a general handover. In addition, in describing the disclosure hereinafter, an operation expressed as being performed by a source cell may be understood as an operation performed by the base station operating the source cell (source base station), and similarly an operation expressed as being performed by a target cell may be understood as an operation performed by the base station operating the target cell (target base station). In addition, unless otherwise specified in the description below, an operation performed by the base station (gNB) may be an operation performed by a source base station or a target base station.

Referring to FIG. 9, the LTM-based cell switch process may include LTM preparation, early synchronization, LTM execution, and LTM completion processes. First, the LTM preparation process is described.

The UE in the RRC_CONNECTED state may report cell measurement information to the base station (gNB) through a measurement report (operation 901). The UE may receive an RRC message including measurement configuration information from the base station in the RRC connection process, measure the signal qualities of a serving cell and neighbor cells by applying the measurement configuration information, and report collected cell measurement information to the base station periodically or when a specific event occurs. For example, the UE may report the cell measurement information to the base station through a MeasurementReport message. The base station may receive the cell measurement information through the measurement report from one or more UEs, and start LTM candidate preparation based on the cell measurement information. Through the LTM candidate preparation procedure, the base station may select one or more candidate target cells for LTM, and determine an LTM candidate configuration to inform the UE of information related to the candidate target cells. The base station may transmit to the UE an RRC message including the LTM candidate configuration determined through the LTM candidate preparation procedure (operation 902). For example, the base station may transmit to the UE an RRCReconfiguration message including configuration for one or more LTM candidate target cells. The UE that has received the RRC reconfiguration message from the base station may transmit to the base station an RRC message indicating that RRC reconfiguration based on the corresponding message has been successfully completed (operation 903). For example, the UE may store the configuration for one or more LTM candidate target cells, and transmit an RRCReconfigurationComplete message to the base station.

Next, the early synchronization process is described.

In order to minimize the interruption time, the UE may perform early synchronization for the candidate target cells before receiving an LTM cell switch command. The early synchronization may include a downlink (DL) synchronization operation to perform the downlink synchronization with the candidate target cells (operation 904a) and an uplink (UL) synchronization operation to perform the uplink synchronization with the candidate target cells (operation 904b).

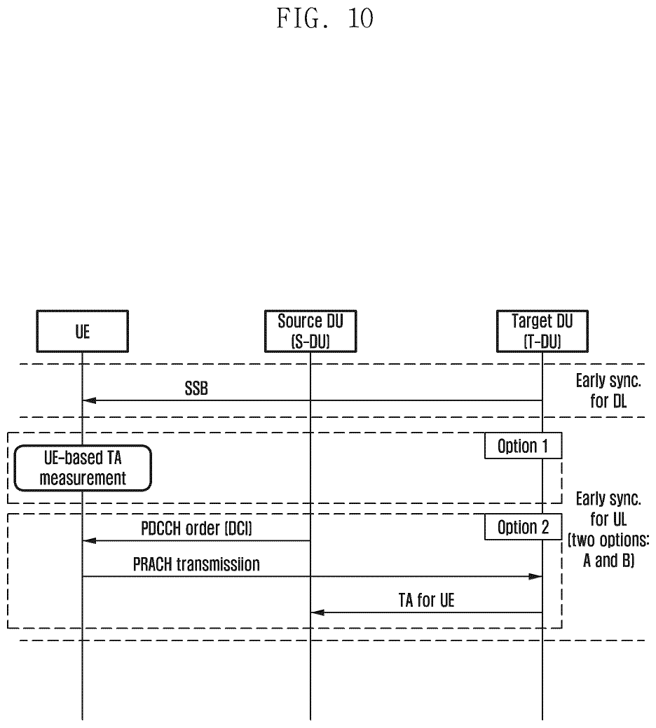

FIG. 10 is a diagram illustrating an early synchronization procedure according to an embodiment of the disclosure.

Referring to FIG. 10, the UE receives a synchronization signal block (SSB) from a configured candidate target cell, and may perform DL synchronization with the candidate target cell based on the received SSB.

The UE may acquire a timing advance (TA) for the candidate target cell in advance in order to perform UL synchronization with the candidate target cell, and use a UE-based scheme or a gNB-based scheme to acquire the TA. According to the UE-based scheme, the UE may acquire the TA for the candidate target cell by directly calculating a timing difference between the source cell and the candidate target cell. According to the gNB-based scheme, the base station may inform the UE of the TA for the candidate target cell, and this may be accomplished through the following process.

The target base station (the base station operating the candidate target cell) transmits information for PRACH transmission to the source base station (the base station operating the source cell). Here, the information for PRACH transmission may be information for contention-free PRACH transmission. The source base station that has received the information for PRACH transmission from the target base station may transmit, to the UE, information for triggering PRACH transmission of the UE. For example, the source base station may trigger PRACH transmission of the UE through a PDCCH (DCI). The UE that has received the information for triggering PRACH transmission may transmit a PRACH to the target base station. The target base station transmits, to the source base station, TA information calculated based on the PRACH received from the UE, and the source base station transmits, to the UE, the TA information received from the target base station, thereby allowing the UE to acquire the TA for the target base station without a random access process.

Returning to FIG. 9, in the LTM execution process, the UE may perform layer-1 measurement on the target candidate cell based on the LTM candidate configuration, generate an L1 measurement report based on the measurement result, and transmit the L1 measurement report to the base station (operation 905). The L1 measurement report may include, for example, a channel state information (CSI) report. The L1 measurement report may be transmitted via a physical layer (or layer-1) or MAC layer signaling. The base station may decide to perform LTM based on the L1 measurement report on the target candidate cell received from the UE. Upon deciding to perform the LTM, the base station may transmit to the UE a cell switch command to switch the serving cell of the UE from the current source cell to the target cell (operation 906). The cell switch command may include information indicating a specific target cell for the LTM among the candidate target cells. For example, the cell switch command may include index information indicating one of the candidate target cells. The UE may perform the LTM for the target cell indicated by the cell switch command among the configured candidate target cells. According to an embodiment, in the case that the gNB-based scheme is used to acquire the TA for UL synchronization, the cell switch command may further include TA information for the target cell. That is, the source cell may transmit the TA information of the target cell received from the target cell to the UE through the cell switch command. In the case that the UE-based scheme is used to acquire the TA for UL synchronization, the cell switch command may not include the TA information for the target cell. According to an embodiment, the cell switch command may be transmitted to the UE through a medium access control (MAC) control element (CE). The UE that has received the cell switch command may release the configuration for the source cell and apply the configuration for the target cell. If the UE acquires valid TA information for the target cell through the UE-based scheme or acquires valid TA information for the target cell through the cell switch command, the UE may perform the LTM without performing a random access procedure to the target cell (RACH-less). If the UE does not acquire valid TA information for the target cell, the UE may perform a random access procedure to the target cell to acquire the TA for the target cell (operation 907).

Finally, in the LTM completion process, the UE may complete the LTM and transmit to the target cell an LTM completion message indicating that the LTM has been completed (operation 908).

Through the LTM-based cell switch described above, the UE can omit the random access procedure to the target cell in the cell switch process, thereby minimizing the interruption time.

Hereinafter, CSI resource configuration and CSI report configuration for L1 measurement reporting in the 5G communication system are described.

The channel state information (CSI) may include channel quality information (CQI), a precoding matrix indicator (PMI), a CSI-RS resource indicator (CRI), a synchronization signal/physical broadcast channel (SS/PBCH) block resource indicator (SSBRI), a layer indicator (LI), a rank indicator (RI), and/or a L1-reference signal received power (L1-RSRP). The base station may control time and frequency resources for CSI measurement and reporting of the UE.

For the CSI measurement and reporting, the UE may be configured with at least one of configuration information CSI-ReportConfig for N (≥1) CSI reports, configuration information CSI-ResourceConfig for M (≥1) RS transmission resources, trigger state lists CSI-AperiodicTriggerStateList, or CSI-SemiPersistentOnPUSCH-TriggerStateList through upper layer signaling.

Specifically, the aforementioned configuration information for the CSI measurement and reporting may include the following information elements (IEs). Note that not all of the IEs described below must be included in each configuration information, and some IEs may be optionally included as needed.

CSI-ReportConfig may include the following IEs as in Table 2.

TABLE 2

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, |

-- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, |
| subbandCQI } | OPTIONAL, -- Need R |
| pmi-FormatIndicator | ENUMERATED { widebandPMI, |
| subbandPMI } | OPTIONAL, -- Need R |
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, |

-- Need R

| | |
|---|---|
| timeRestrictionForChannelMeasurements | ENUMERATED {configured, |

notConfigured},

| | |
|---|---|
| timeRestrictionForInterferenceMeasurements | ENUMERATED |

{configured, notConfigured},

| | |
|---|---|
| codebookConfig | CodebookConfig |

OPTIONAL, -- Need R

| | |
|---|---|
| dummy | ENUMERATED {n1, n2} |
| OPTIONAL, -- Need R | |
| groupBasedBeamReporting | CHOICE { |
| enabled | NULL, |
| disabled | SEQUENCE { |
| nrofReportedRS | ENUMERATED {n1, n2, n3, n4} |

```
OPTIONAL -- Need S
    }
  },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

| | |
|---|---|
| } | OPTIONAL |

-- Need R
]]
}
CSI-ReportPeriodicityAndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| PortIndexFor8Ranks ::= | CHOICE { | |
|---|---|---|
| portIndex8 | SEQUENCE{ | |
| rank1-8 | PortIndex8 | OPTIONAL, |

-- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| portIndex4 | SEQUENCE{ | |
|---|---|---|
| rank1-4 | PortIndex4 | OPTIONAL, |

-- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| portIndex2 | SEQUENCE{ | |
|---|---|---|
| rank1-2 | PortIndex2 | OPTIONAL, |

-- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

CSI-ReportConfig field descriptions
carrier
Indicates in which serving cell the CSI-ResourceConfig indicated below are to be
found. If the field is absent, the resources are on the same serving cell as this report
configuration.
codebookConfig
Codebook configuration for Type-1 or Type-II including codebook subset
restriction.
cqi-FormatIndicator
Indicates whether the UE shall report a single (wideband) or multiple (subband)
CQI. (see TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-
ResourceConfig included in the configuration of the serving cell indicated with the
field “carrier” above. The CSI-ResourceConfig indicated here contains only CSI-IM
resources. The bwp-Id in that CSI-ResourceConfig is the same value as the bwp-Id
in the CSI-ResourceConfig indicated by resourcesForChannelMeasurement.
csi-Reporting Band
Indicates a contiguous or non-contiguous subset of subbands in the bandwidth part
which CSI shall be reported for. Each bit in the bit-string represents one subband.
The right-most bit in the bit string represents the lowest subband in the BWP. The
choice determines the number of subbands (subbands3 for 3 subbands, subbands4
for 4 subbands, and so on) (see TS 38.214 [19], clause 5.2.1.4). This field is absent
if there are less than 24 PRBs (no sub band) and present otherwise, the number of
sub bands can be from 3 (24 PRBs, sub band size 8) to 18 (72 PRBs, sub band size
4).
dummy
This field is not used in the specification. If received it shall be ignored by the UE.
groupBasedBeamReporting
Turning on/off group beam based reporting (see TS 38.214 [19], clause 5.2.1.4)
non-PMI-PortIndication
Port indication for RI/CQI calculation. For each CSI-RS resource in the linked
ResourceConfig for channel measurement, a port indication for each rank R,
indicating which R ports to use. Applicable only for non-PMI feedback (see TS
38.214 [19], clause 5.2.1.4.2).
The first entry in non-PMI-PortIndication corresponds to the NZP-CSI-RS-
Resource indicated by the first entry in nzp-CSI-RS-Resources in the NZP-CSI-RS-
ResourceSet indicated in the first entry of nzp-CSI-RS-ResourceSetList of the CSI-
ResourceConfig whose CSI-ResourceConfigId is indicated in a CSI-MeasId
together with the above CSI-ReportConfigId; the second entry in non-PMI-
PortIndication corresponds to the NZP-CSI-RS-Resource indicated by the second
entry in nzp-CSI-RS-Resources in the NZP-CSI-RS-ResourceSet indicated in the
first entry of nzp-CSI-RS-ResourceSetList of the same CSI-ResourceConfig, and so
on until the NZP-CSI-RS-Resource indicated by the last entry in nzp-CSI-RS-
Resources in the in the NZP-CSI-RS-ResourceSet indicated in the first entry of nzp-
CSI-RS-ResourceSetList of the same CSI-ResourceConfig. Then the next entry
corresponds to the NZP-CSI-RS-Resource indicated by the first entry in nzp-CSI-
RS-Resources in the NZP-CSI-RS-ResourceSet indicated in the second entry of
nzp-CSI-RS-ResourceSetList of the same CSI-ResourceConfig and so on.
nrofReportedRS
The number (N) of measured RS resources to be reported per report setting in a non-
group-based report. N <= N_max, where N_max is either 2 or 4 depending on UE
capability.
(see TS 38.214 [19], clause 5.2.1.4) When the field is absent the UE applies the
value 1
nzp-CSI-RS-ResourcesForInterference
NZP CSI RS resources for interference measurement. csi-ResourceConfigId of a
CSI-ResourceConfig included in the configuration of the serving cell indicated with
the field “carrier” above. The CSI-ResourceConfig indicated here contains only
NZP-CSI-RS resources. The bwp-Id in that CSI-ResourceConfig is the same value
as the bwp-Id in the CSI-ResourceConfig indicated by
resourcesForChannelMeasurement.
p0alpha
Index of the p0-alpha set determining the power control for this CSI report
transmission (see TS 38.214 [19], clause 6.2.1.2).
pdsch-BundleSizeForCSI
PRB bundling size to assume for CQI calculation when reportQuantity is
CRI/RI/i1/CQI. If the field is absent, the UE assumes that no PRB bundling is
applied (see TS 38.214 [19], clause 5.2.1.4.2).
pmi-FormatIndicator
Indicates whether the UE shall report a single (wideband) or multiple (subband)
PMI. (see TS 38.214 [19], clause 5.2.1.4).
pucch-CSI-ResourceList
Indicates which PUCCH resource to use for reporting on PUCCH.
reportConfigType
Time domain behavior of reporting configuration
reportFreqConfiguration
Reporting configuration in the frequency domain. (see TS 38.214 [19], clause
5.2.1.4).
reportQuantity
The CSI related quantities to report. Corresponds to L1 parameter ‘ReportQuantity’
(see TS 38.214 [19], clause 5.2.1).
reportSlotConfig
Periodicity and slot offset (see TS 38.214 [19], clause 5.2.1.4).
reportSlotConfig-v1530
Extended value range for reportSlotConfig for semi-persistent CSI on PUSCH. If
the field is present, the UE shall ignore the value provided in the legacy field
(semiPersistentOnPUSCH.reportSlotConfig).
reportSlotOffsetList
Timing offset Y for semi persistent reporting using PUSCH. This field lists the
allowed offset values. This list must have the same number of entries as the pusch-
TimeDomainAllocationList in PUSCH-Config. A particular value is indicated in
DCI. The network indicates in the DCI field of the UL grant, which of the
configured report slot offsets the UE shall apply. The DCI value 0 corresponds to
the first report slot offset in this list, the DCI value 1 corresponds to the second
report slot offset in this list, and so on. The first report is transmitted in slot n + Y,
second report in n + Y + P, where P is the configured periodicity.
Timing offset Y for aperiodic reporting using PUSCH. This field lists the allowed
offset values. This list must have the same number of entries as the pusch-
TimeDomainAllocationList in PUSCH-Config. A particular value is indicated in
DCI. The network indicates in the DCI field of the UL grant, which of the
configured report slot offsets the UE shall apply. The DCI value 0 corresponds to
the first report slot offset in this list, the DCI value 1 corresponds to the second
report slot offset in this list, and so on (see TS 38.214 [19], clause 5.2.3).
resourcesForChannelMeasurement
Resources for channel measurement. csi-ResourceConfigId of a CSI-
ResourceConfig included in the configuration of the serving cell indicated with the
field “carrier” above. The CSI-ResourceConfig indicated here contains only NZP-
CSI-RS resources and/or SSB resources. This CSI-ReportConfig is associated with
the DL BWP indicated by bwp-Id in that CSI-ResourceConfig.
subbandSize
Indicates one out of two possible BWP-dependent values for the subband size as
indicated in TS 38.214 [19], table 5.2.1.4-2 . If csi-ReportingBand is absent, the UE
shall ignore this field.
timeRestrictionForChannelMeasurements
Time domain measurement restriction for the channel (signal) measurements (see
TS 38.214 [19], clause 5.2.1.1)
timeRestrictionForInterferenceMeasurements
Time domain measurement restriction for interference measurements (see TS
38.214 [19], clause 5.2.1.1)

CSI-ResourceConfig may include IEs as in Table 3 below.

TABLE 3

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP- |

CSI-RS-ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId
OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic |

},
...
}

CSI-ResourceConfig field descriptions
bwp-Id
The DL BWP which the CSI-RS associated with this CSI-ResourceConfig are
located in (see TS 38.214 [19], clause 5.2.1.2
csi-ResourceConfigId
Used in CSI-ReportConfig to refer to an instance of CSI-ResourceConfig
csi-RS-ResourceSetList
Contains up to maxNrofNZP-CSI-RS-ResourceSetsPerConfig resource sets if
ResourceConfigType is ‘aperiodic’ and 1 otherwise (see TS 38.214 [19], clause
5.2.1.2)
csi-SSB-ResourceSetList
List of SSB resources used for beam measurement and reporting in a resource set
(see TS 38.214 [19], section FFS_Section)
resourceType
Time domain behavior of resource configuration (see TS 38.214 [19], clause
5.2.1.2). It does not apply to resources provided in the csi-SSB-ResourceSetList.

According to an embodiment, NZP-CSI-RS-ResourceSet may include IEs as in Table 4 below.

TABLE 4

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-R |

S-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
    OPTIONAL, -- Need R
  ...
}
NZP-CSI-RS-ResourceSet field descriptions
aperiodicTriggeringOffset
Offset X between the slot containing the DCI that triggers a set of aperiodic NZP
CSI-RS resources and the slot in which the CSI-RS resource set is transmitted. The
value 0 corresponds to 0 slots, value 1 corresponds to 1 slot, value 2 corresponds to
2 slots, value 3 corresponds to 3 slots, value 4 corresponds to 4 slots, value 5
corresponds to 16 slots, value 6 corresponds to 24 slots. When the field is absent the
UE applies the value 0.
nzp-CSI-RS-Resources
NZP-CSI-RS-Resources associated with this NZP-CSI-RS resource set (see TS
38.214 [19], clause 5.2). For CSI, there are at most 8 NZP CSI RS resources per
resource set
repetition
Indicates whether repetition is on/off. If the field is set to ‘OFF’ or if the field is
absent, the UE may not assume that the NZP-CSI-RS resources within the resource
set are transmitted with the same downlink spatial domain transmission filter and
with same NrofPorts in every symbol (see TS 38.214 [19], clauses 5.2.2.3.1 and
5.1.6.1.2). Can only be configured for CSI-RS resource sets which are associated
with CSI-ReportConfig with report of L1 RSRP or “no report”
trs-Info
Indicates that the antenna port for all NZP-CSI-RS resources in the CSI-RS resource
set is same. If the field is absent or released the UE applies the value “false” (see TS
38.214 [19], clause 5.2.2.3.1).
```

According to an embodiment, CSI-SSB-ResourceSet may include IEs as in Table 5 below.

TABLE 5

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

ResourcePerSet)) OF SSB-Index,
...
}

According to an embodiment, CSI-IM-ResourceSet may include IEs as in Table 6 below.

TABLE 6

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

ResourcesPerSet)) OF CSI-IM-ResourceId,
...
}

CSI-IM-ResourceSet field descriptions
csi-IM-Resources
CSI-IM-Resources associated with this CSI-IM-ResourceSet (see TS 38.214 [19],
clause 5.2)

According to an embodiment, CSI-AperiodicTriggerStateList may include IEs as in Table 7 below.

TABLE 7

| | |
|---|---|
| CSI-AperiodicTriggerStateList ::= | SEQUENCE (SIZE (1..maxNrOfCSI- |

Aperiodic Triggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger) OF CSI-
AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |
| ResourceSetsPerConfig) | OPTIONAL, -- Cond CSI-IM-ForInterference |
| nzp-CSI-RS-ResourcesForInterference | INTEGER (1..maxNrofNZP-CSI- |
| RS-ResourceSetsPerConfig) | OPTIONAL, -- Cond NZP-CSI-RS- |

ForInterference
...
}
CSI-AssociatedReportConfigInfo field descriptions
csi-IM-ResourcesForInterference
CSI-IM-ResourceSet for interference measurement. Entry number in csi-IM-
ResourceSetList in the CSI-ResourceConfig indicated by csi-IM-
ResourcesForInterference in the CSI-ReportConfig indicated by reportConfigId
above (1 corresponds to the first entry, 2 to the second entry, and so on). The
indicated CSI-IM-ResourceSet should have exactly the same number of resources
like the NZP-CSI-RS-ResourceSet indicated in nzp-CSI-RS-ResourcesforChannel.
csi-SSB-ResourceSet
CSI-SSB-ResourceSet for channel measurements. Entry number in csi-SSB-
ResourceSetList in the CSI-ResourceConfig indicated by
resourcesForChannelMeasurement in the CSI-ReportConfig indicated by
reportConfigId above (1 corresponds to the first entry, 2 to the second entry, and so
on).
nzp-CSI-RS-ResourcesForInterference
NZP-CSI-RS-ResourceSet for interference measurement. Entry number in nzp-CSI-
RS-ResourceSetList in the CSI-ResourceConfig indicated by nzp-CSI-RS-
ResourcesForInterference in the CSI-ReportConfig indicated by reportConfigId
above (1 corresponds to the first entry, 2 to the second entry, and so on).
qcl-info
List of references to TCI-States for providing the QCL source and QCL type for
each NZP-CSI-RS-Resource listed in nzp-CSI-RS-Resources of the NZP-CSI-RS-
ResourceSet indicated by nzp-CSI-RS-ResourcesforChannel. Each TCI-StateId
refers to the TCI-State which has this value for tci-StateId and is defined in tci-
StatesToAddModList in the PDSCH-Config included in the BWP-Downlink
corresponding to the serving cell and to the DL BWP to which the
resourcesForChannelMeasurement (in the CSI-ReportConfig indicated by
reportConfigId above) belong to. First entry in qcl-info-forChannel corresponds to
first entry in nzp-CSI-RS-Resources of that NZP-CSI-RS-ResourceSet, second entry
in qcl-info-forChannel corresponds to second entry in nzp-CSI-RS-Resources, and
so on (see TS 38.214 [19], clause 5.2.1.5.1)
reportConfigId
The reportConfigId of one of the CSI-ReportConfigToAddMod configured in CSI-
MeasConfig
resourceSet
NZP-CSI-RS-ResourceSet for channel measurements. Entry number in nzp-CSI-
RS-ResourceSetList in the CSI-ResourceConfig indicated by
resourcesForChannelMeasurement in the CSI-ReportConfig indicated by
reportConfigId above (1 corresponds to the first entry, 2 to the second entry, and so
on).

According to an embodiment, CSI-SemiPersistentOnPUSCH-TriggerStateList may include IEs as in Table 8 below.

TABLE 8

| | |
|---|---|
| CSI-SemiPersistentOnPUSCH-TriggerStateList ::= | SEQUENCE(SIZE |

(1..maxNrOfSemiPersistentPUSCH-Triggers)) OF CSI-
SemiPersistentOnPUSCH-TriggerState

| | |
|---|---|
| CSI-SemiPersistentOnPUSCH-TriggerState ::= | SEQUENCE |
| associatedReportConfigInfo | CSI-ReportConfigId, |

...
}

Each report configuration CSI-ReportConfig may be associated with one downlink (DL) bandwidth part identified by a bandwidth part identifier bwp-Id, which is an upper layer parameter given by a CSI resource configuration CSI-ResourceConfig associated with the corresponding report configuration. A time domain report for each report configuration CSI-ReportConfig supports ‘aperiodic’, ‘semi-persistent’ or ‘periodic’ scheme, which may be configured from the base station to the UE by the upper layer parameter reportConfigType. The semi-persistent CSI report method supports a semi-persistent report on PUCCH configured by semi-PersistentOnPUCCH and a semi-persistent reporting on PUSCH configured by semi-PersistentOnPUSCH. In the case of the periodic or semi-persistent CSI report, the UE may be configured with PUCCH resources or PUSCH resources to transmit CSI from the base station through upper layer signaling. The periodicity and slot offset for transmitting CSI may be given with a numerology of the uplink (UL) bandwidth part configured to transmit the CSI report. In the case of aperiodic CSI report, the UE may be scheduled for the PUSCH resource for transmitting CSI from the base station through L1 signaling (e.g., DCI format 0_1).

For the aforementioned CSI resource configuration CSI-ResourceConfig, each CSI resource configuration CSI-ReportConfig may include S (≥1) CSI resource sets (given by the upper layer parameter csi-RS-ResourceSetList). The CSI resource set list may consist of a non-zero power (NZP) CSI-RS resource set and an SS/PBCH block set, or may consist of a CSI-interference measurement (CSI-IM) resource set. Each CSI resource configuration may be located in a downlink (DL) bandwidth part identified by the upper layer parameter bwp-Id, and the CSI resource configuration may be linked to a CSI report configuration in the same downlink bandwidth part. The time domain operation of the CSI-RS resources in the CSI resource configuration may be configured with one of ‘aperiodic’, ‘periodic’ or ‘semi-persistent’ from the upper layer parameter resourceType. For periodic or semi-persistent CSI resource configuration, the number of CSI-RS resource sets may be limited to S=1, and the configured periodicity and slot offset may be given with a numerology of a downlink bandwidth part identified by bwp-Id. The UE may be configured with one or more CSI resource configurations for channel or interference measurement from the base station through upper layer signaling, and for example, the CSI resource configuration may include at least one of the following resources.
CSI-IM resource for interference measurement.
NZP CSI-RS resource for interference measurement.
NZP CSI-RS resource for channel measurement.

For CSI-RS resource sets associated with a resource configuration where the upper layer parameter resourceType is configured with ‘aperiodic’, ‘periodic’, or ‘semi-persistent’, a trigger state for a CSI report configuration where reportType is configured with ‘aperiodic’ and a resource configuration for channel or interference measurement for one or more component cells (CCs) may be configured the upper layer parameter CSI-AperiodicTriggerStateList.

The aperiodic CSI report of the UE may use PUSCH, the periodic CSI report may use PUCCH, and the semi-persistent CSI report may be performed using PUSCH when triggered or activated by DCI and may be performed using PUCCH after being activated by MAC control element (MAC CE).

The CSI resource configuration may also be configured with aperiodic, periodic, or semi-persistent. A combination between CSI report configuration and CSI resource configuration may be based on Table 9 below.

TABLE 9

| CSI-RS | Periodic CSI | Semi-Persistent CSI | Aperiodic CSI |
|---|---|---|---|
| Configuration | Reporting | Reporting | Reporting |
| Periodic CSI- | No dynamic | For reporting on | Triggered by DCI; |
| RS | triggering/activation | PUCCH, the UE | additionally, activation |
| | | receives an activation | command [10, TS |
| | | command [10, TS | 38.321] possible as |
| | | 38.321]; for reporting | defined in Subclause |
| | | on PUSCH, the UE | 5.2.1.5.1. |
| | | receives triggering on | |
| | | DCI | |
| Semi- | Not Supported | For reporting on | Triggered by DCI; |
| Persistent CSI- | | PUCCH, the UE | additionally, activation |
| RS | | receives an activation | command [10, TS |
| | | command [10, TS | 38.321] possible as |
| | | 38.321]; for reporting | defined in Subclause |
| | | on PUSCH, the UE | 5.2.1.5.1. |
| | | receives triggering on | |
| | | DCI | |
| Aperiodic CSI- | Not Supported | Not Supported | Triggered by DCI; |
| RS | | | additionally, activation |
| | | | command [10, TS |
| | | | 38.321] possible as |
| | | | defined in Subclause |
| | | | 5.2.1.5.1. |

Aperiodic CSI reporting may be triggered by, for example, a “CSI request” field in DCI format 0_1 corresponding to scheduling DCI for PUSCH. The UE may obtain DCI format 0_1 by monitoring PDCCH, and obtain resource allocation information for PUSCH and the CSI request field from DCI format 0_1. The CSI request field may be configured with NTS (=0, 1, 2, 3, 4, 5, or 6) bits, and the NTS may be determined by the upper layer parameter reportTriggerSize. One trigger state among one or more aperiodic CSI reporting trigger states that can be configured by the upper layer parameter CSI-AperiodicTriggerStateList may be triggered by the CSI request field.
If all bits in the CSI request field are 0, this may mean that no CSI report is requested.
If the number of CSI trigger states (M) in the configured CSI-AperiodicTriggerStateList is greater than 2N\hat{ }TS−1, then according to the predefined mapping relationship, the M CSI trigger states may be mapped to 2N\hat{ }TS−1 CSI trigger states, and one of the trigger states of 2N\hat{ }TS−1 may be indicated by the CSI request field.
If the number of CSI trigger states (M) in the configured CSI-AperiodicTriggerStateList is less than or equal to 2N\hat{ }TS−1, one of the M CSI trigger states may be indicated by the CSI request field.

Table 10 below shows an example of the relationship between the CSI request field and the CSI trigger state that can be indicated by it.

TABLE 10

| CSI | | | |
|---|---|---|---|
| request | | CSI- | CSI- |
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may perform measurements on a CSI resource within a CSI trigger state triggered by the CSI request field, and generate CSI (including at least one of CQI, PMI, CRI, SSBRI, LI, RI, or L1-RSRP) therefrom. The UE may transmit the generated CSI by using a PUSCH scheduled by DCI format 0_1. When a 1-bit uplink shared channel (UL-SCH) indicator in DCI format 0_1 indicates “1”, uplink data from UL-SCH and the generated CSI may be multiplexed and transmitted on a PUSCH resource scheduled by DCI format 0_1. When the UL-SCH indicator in DCI format 0_1 indicates “0”, only CSI may be transmitted without uplink data on a PUSCH resource scheduled by DCI format 0_1.

The robust link adaptation scheme refers to a phenomenon in which the throughput is temporarily reduced because the target cell does not have information about the channel state of the UE immediately after a cell switch. Generally, the base station performs data transmission and reception with the UE by applying an appropriate MCS level, number of layers, and precoding based on channel state information (CSI) reported from the UE. For example, the base station may determine the MCS level based on a channel quality indicator (CQI), determine the number of layers based on a rank indicator (RI), and determine the precoder based on a precoding matrix indicator (PMI). However, if the target cell does not receive the channel state information from the UE immediately after a cell switch, the base station cannot apply an appropriate MCS level, number of layers, and precoding, and thus the throughput may temporarily be degraded.

In general, after the completion of the cell switch according to the robust link adaptation scheme, the operation of the target cell is as follows.
Before receiving CSI feedback from the UE after the cell switch
The target cell may perform link adaptation (LA) based on the initial
MCS.
After receiving CSI feedback from the UE after the cell switch

-Upon receiving CQI through CSI feedback, the target cell may perform link adaptation based on the MCS estimated through the CQI to SINR to MCS mapping.
Upon receiving RI through CSI feedback, the target cell may allocate the number of layers corresponding to the received RI.
Upon receiving PMI through CSI feedback, the target cell may apply precoding based on the PMI.

As such, the length of a throughput-degraded section according to the robust link adaptation scheme is determined by a time when the target cell acquires the channel state information (CSI) from the UE after the cell switch.

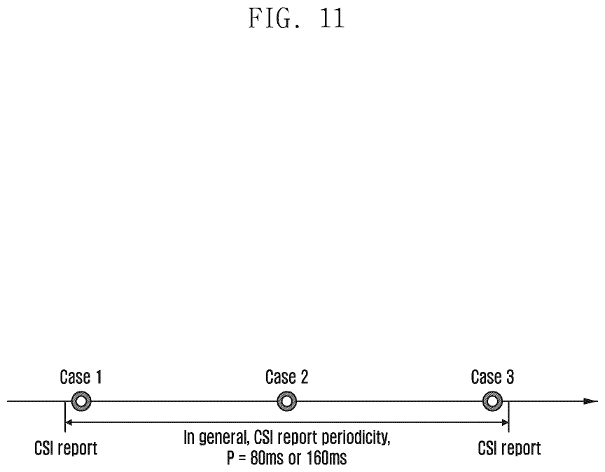

FIG. 11 is a diagram illustrating a relationship between a cell switch completion time and a CSI reporting time according to an embodiment of the disclosure.

Referring to FIG. 11, the relationship between the cell switch completion time and the CSI report time is explained by dividing it into three cases as follows.
Case 1: In the case that the cell switch completion time is immediately after the CSI report.
Case 2: In the case that the cell switch completion time is midway between immediately after the CSI report and immediately before the next CSI report.
Case 3: In the case that the cell switch completion time is immediately before the CSI report.

In Case 1 or Case 2, since the cell switch is completed after the UE has already reported CSI, the target cell must wait until the UE reports the next CSI to acquire the CSI from the UE. In Case 1, since the cell switch is completed immediately after CSI is reported, it may take a considerable amount of time until the next CSI is reported, and in Case 2, since the cell switch is completed at a midpoint between immediately after the CSI report and immediately before the next CSI report, it may take a certain amount of time, although shorter than Case 1, until the UE reports the next CSI. On the other hand, in Case 3, since the cell switch is completed immediately before the UE reports CSI, the UE will report the CSI immediately after the cell switch is completed, and therefore the target cell may acquire the CSI from the UE within a short period of time after the completion of the cell switch.

When the CSI report periodicity is P, the time required for the target cell to acquire the CSI from the UE after the cell switch for each case is as shown in Table 11.

TABLE 11

| | CSI acquisition | |
|---|---|---|
| | required time | |
| Case | [unit: ms] | Description |
| Case 1 | About P ms | It takes a considerable amount of time |
| | | to acquire CSI from the target cell |
| | | immediately after the cell switch. |
| Case 2 | About P/2 ms | It takes some time to acquire CSI from |
| | | the target cell immediately after the |
| | | cell switch. |
| Case 3 | Up to a few ms | CSI can be acquired and utilized from |
| | | the target cell immediately after the |
| | | cell switch. |

In order to enable the CSI of the UE to be utilized immediately after the completion of the cell switch, it is optimal to minimize the time required for the target cell to acquire the CSI from the UE after the cell switch by transmitting the cell switch completion message just before the CSI report of the UE as in Case 3. However, there are several difficulties in transmitting the cell switch completion message by considering the timing of the CSI report to the target cell. For example, a cell switch may occur too quickly or too early, or there may be difficulties in allocating PUCCH resources for CSI reporting.

The disclosure proposes a method for minimizing throughput degradation due to the robust link adaptation scheme by allowing the UE to pre-acquire the CSI for the target cell before the cell switch is completed and to immediately transmit the CSI to the target cell just after the cell switch is completed. The disclosure proposes a method for transmitting CSI information of the target cell together when the UE transmits the cell switch complete (e.g., handover complete) message to the target cell, through which the target cell can support fast link adaptation for the UE connected through the cell switch (e.g., handover).

Hereinafter, a CSI pre-acquisition method and an LTM cell switch method capable of fast link adaptation based thereon according to various embodiments of the disclosure will be described with reference to the drawings. It should be noted that the various embodiments described herein may be implemented in combination with each other. In addition, not all of the various embodiments described herein are essential components for implementing the disclosure, and at least some embodiments may or may not be optionally implemented to provide the CSI pre-acquisition method and device proposed in the disclosure.

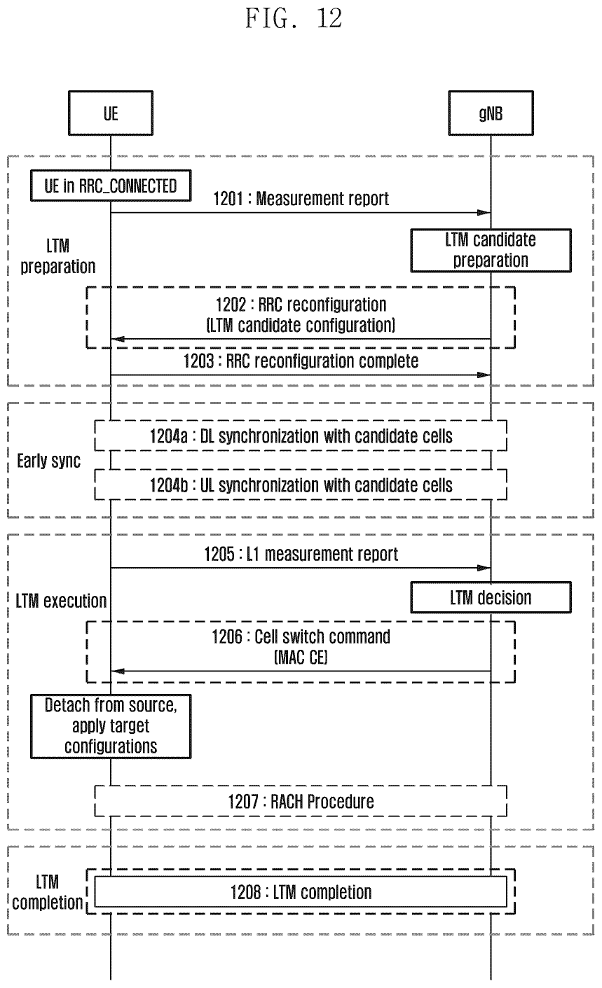

FIG. 12 is a diagram illustrating an LTM cell switch procedure supporting fast link adaptation according to an embodiment of the disclosure.

Operations 1201, 1202, 1203, 1204a, 1204b, 1205, 1206, 1207, and 1208 illustrated in FIG. 12 may respectively correspond to operations 901, 902, 903, 904a, 904b, 905, 906, 907, and 908 described above with reference to FIG. 9, and thus descriptions of those operations that are the same are omitted.

First, a method for configuring CSI-RS resources for a target cell in order to pre-acquire CSI of a candidate target cell before a UE performs a cell switch to the target cell will be described.

Referring to FIG. 12, in operation 1202, a base station (gNB) may determine an LTM candidate configuration for informing the UE of information related to candidate target cells, and transmit an RRC message including the determined LTM candidate configuration to the UE. According to an embodiment of the disclosure, when the base station transmits an RRC reconfiguration message to the UE in operation 1202 of the LTM cell switch procedure, the RRC reconfiguration message may include configuration information for CSI measurement and report of the candidate target cell. The configuration information for CSI measurement and report of the candidate target cell included in the RRC reconfiguration message may include at least some of the information elements (IEs) described above through Tables 2 to 8 or their sub-IEs.

According to an embodiment, the RRC reconfiguration message may include a CSI-RS resource configuration for the candidate target cell. The CSI-RS resource configuration of the candidate target cell is for pre-acquiring the CSI of the candidate target cell before a cell switch to the target cell is performed, and may be included in an LTM candidate configuration for indicating information about the candidate target cell independently of the CSI-RS resource configuration for a source cell currently connected to the UE, or may be configured to have an association with another information element (IE) included in the LTM candidate configuration. According to an embodiment, the CSI-RS resource configuration of the target cell may be configured cell-specifically or UE-specifically. Here, being configured cell-specifically means that a common CSI-RS resource is configured for UEs in the cell, and being configured UE-specifically means that an individual CSI-RS resource is configured for each UE. The CSI-RS resource configuration of the candidate target cell may be transmitted from each candidate target cell to the source cell in the LTM candidate preparation process. The source cell may include the CSI-RS resource configuration of the candidate target cell, received from the candidate target cell, in the RRC reconfiguration message and notify it to the UE. The CSI-RS resource configuration of the candidate target cell is intended to pre-acquire the CSI of the candidate target cell and then utilize it for link adaptation, and an NZP-CSI-RS resource IE, which can be used to measure the corresponding report quantity, may be included in the CSI-RS resource configuration of the candidate target cell. The NZP-CSI-RS resource IE may include, for example, sub-IEs as in Table 12.

TABLE 12
NZP-CSI-RS-Resource ::= SEQUENCE {
nzp-CSI-RS-ResourceId NZP-CSI-RS-ResourceId,
resourceMapping CSI-RS-ResourceMapping,
powerControlOffset INTEGER (−8..15),
powerControlOffsetSS ENUMERATED {db−3, db0, db3, db6} OPTIONAL, -- Need
R
scramblingID ScramblingId,
periodicityAndOffset CSI-ResourcePeriodicity AndOffset OPTIONAL, -- Cond
PeriodicOrSemiPersistent
qcl-InfoPeriodicCSI-RS TCI-StateId OPTIONAL, -- Cond Periodic
...
}
CSI-RS-ResourceMapping ::= SEQUENCE {
frequencyDomainAllocation CHOICE {
row1 BIT STRING (SIZE (4)),
row2 BIT STRING (SIZE (12)),
row4 BIT STRING (SIZE (3)),
other BIT STRING (SIZE (6))
},
nrofPorts ENUMERATED {p1,p2,p4,p8,p12,p16,p24,p32},
firstOFDMSymbolInTimeDomain INTEGER (0..13),
firstOFDMSymbolInTimeDomain2 INTEGER (2..12) OPTIONAL, -- Need R
cdm-Type ENUMERATED {noCDM, fd-CDM2, cdm4-FD2-TD2, cdm8-FD2-
TD4},
density CHOICE {
dot5 ENUMERATED {evenPRBs, oddPRBs},
one NULL,
three NULL,
spare NULL
},
freqBand CSI-FrequencyOccupation,
...
}

According to an embodiment, the RRC reconfiguration message may include a CSI report configuration for the candidate target cell. The CSI report configuration for the candidate target cell may be, for example, CSI-ReportConfig. The CSI report configuration is for configuring a method of reporting the pre-acquired CSI of the candidate target cell, and may be included in an LTM candidate configuration for indicating information about the candidate target cell independently of the CSI report configuration for a source cell currently connected to the UE, or may be configured to have an association with an IE included in the LTM candidate configuration. In addition, the CSI report configuration for the candidate target cell may be configured in association with the CSI-RS resource configuration for the candidate target cell used when reporting the CSI for the candidate target cell. Unlike the L1 measurement report (operation 1205) for LTM decision, the CSI report for the candidate target cell is intended to be used for link adaptation after the UE pre-acquires the CSI of the target cell to which a cell switch is performed, and report values of the CSI report configuration for the candidate target cell may include at least some or all of CRI, RI, PMI, and CQI. For example, in the case that the CSI report configuration for the candidate target cell is defined through the CSI-ReportConfig IE, the ‘reportQuantity’ of the CSI-ReportConfig may be configured as ‘cri-RI-PMI-CQI’. Since the CSI for the pre-acquired target cell only needs to be transmitted once when the LTM complete message is transmitted, the transmission type may be configured as aperiodic or event. According to the aperiodic type, the UE may report aperiodic CSI based on triggering of the base station with the previously defined CSI report type. The base station may trigger the aperiodic CSI report for the target candidate cell of the UE through a cell switch command, or separately, trigger the CSI report based on any signaling including DCI, MAC CE, and RRC. Alternatively, even if the base station does not explicitly trigger the aperiodic CSI report for the candidate target cell, the UE may regard the aperiodic CSI report as being implicitly triggered upon receiving the cell switch command and perform the CSI report for the target cell when transmitting the LTM complete message. According to the event type, the UE may report the CSI for the target cell together when transmitting the LTM complete message even without triggering by the base station.

For example, in the case that the CSI report configuration for the candidate target cell is defined through the CSI-ReportConfig IE, the reportConfigType of the CSI-ReportConfig may be configured based on one of the following:
Alt 1: It may be configured using the previously defined type (periodic, aperiodic, semi-persistent). For example, if an aperiodic type is configured, the reportConfigType may be configured as ‘aperiodic’.
Alt 2: The reportConfigType may be configured by defining a new type. The new type may be defined as ‘event’, for example, and if an ‘event type’ is configured, the reportConfigType may be configured as ‘event’. In the above description, the name of the newly defined type for one-time CSI report for the target cell, event, is only for example and does not limit the scope of the disclosure, and it should be noted that any name other than ‘event’ may be newly defined to support similar functions.

Next, a method for instructing whether or not the UE will report the CSI to the target cell when transmitting an LTM completion message is described.

Referring to FIG. 12, when the base station transmits the cell switch command to the UE through MAC CE in operation 1206, it may instruct through the MAC CE whether or not to report the CSI for the candidate target cell. Even if a method is configured to enable the UE to pre-acquire the CSI through the CSI-RS resource configuration for the candidate target cell and to feed the CSI back through the CSI report configuration for the candidate target cell, the base station may instruct whether or not the UE will report the CSI to the target cell in an actual LTM completion process. Accordingly, when transmitting MAC CE for the cell switch command to the UE, the base station may enable the MAC CE to include a 1-bit flag to indicate whether or not the UE will report the CSI to the target cell. For example, the UE may be enabled not to report the pre-acquired CSI to the target cell in the LTM completion process if the 1-bit flag value is ‘0’, and to report the pre-acquired CSI to the target cell in the LTM completion process if the 1-bit flag value is ‘1’. Conversely, the UE may also be enabled not to report the pre-acquired CSI to the target cell in the LTM completion process if the 1-bit flag value is ‘1’, and to report the pre-acquired CSI to the target cell in the LTM completion process if the 1-bit flag value is ‘0’.

According to an embodiment, when the base station transmits the cell switch command to the UE through the MAC CE, the MAC CE may include a field indicating a CSI-RS resource or a CSI-RS resource set to indicate for which CSI-RS resource the UE will report an estimated CSI. The field indicating the CSI-RS resource or the CSI-RS resource set may be included in the MAC CE for the cell switch command if the 1-bit flag value indicating whether or not to report the CSI to the target cell indicates to report the CSI to the target cell (e.g., if the value is ‘1’). The field indicating the CSI-RS resource or the CSI-RS resource set may indicate a CSI-RS resource ID or a CSI-RS resource set ID to be used for CSI estimation of the target cell based on the CSI-RS resource configuration of the candidate target cell.

The base station may or may not instruct the UE whether to report the CSI to the target cell. In case of instructing the UE whether to report the CSI to the target cell, the base station may include, in the MAC CE for the cell switch command, the 1-bit flag and/or CSI-RS resource or CSI-RS resource set for indicating whether the UE will report the CSI to the target cell, and transmit it to the UE.

In case that the base station does not instruct the UE whether to report the CSI to the target cell, the UE may expect to be instructed by the base station whether to report the CSI to the target cell, or the UE may or may not report the CSI to the target cell based on a default operation of either reporting the CSI to the target cell or not reporting the CSI to the target cell. The default operation may be pre-configured or may be configured by the base station in advance.

Next, a method for the UE to report the CSI for the target cell is described. Referring to FIG. 12, when the UE transmits a cell switch complete message in operation 1208, it may transmit a CSI report for the target cell together.

A method for transmitting the cell switch complete message (e.g., RRC reconfiguration complete Msg) is different for each of a case where the early synchronization operation succeeds and thus the random access procedure is not performed, and a case where the early synchronization operation fails or the TA value is invalid and thus the random access procedure is performed.
Alt 1. In case of not performing the random access procedure (the early synchronization operation succeeds).

If the early synchronization operation succeeds and thus the random access procedure is not performed, the cell switch complete message may be transmitted based on the first UL grant received from the base station after the cell switch. In this case, the cell switch complete message is an RRC message (L3), and the CSI report to be transmitted in the disclosure corresponds to uplink control information (UCI) (L1). Therefore, the resources allocated by the first UL grant may be allocated in a size sufficient to transmit both the RRC message and the UCI.
Alt 2. In case of performing the random access procedure (the early synchronization operation fails).

If the random access is performed, the cell switch complete message may be transmitted via Msg.3. The UL grant for transmitting Msg.3 is allocated through Msg.2, and the resources allocated by Msg.2 may be allocated in a size sufficient to transmit both the Msg.3 and the UCI for the CSI report.

Through the indication whether to report the CSI for the target cell as described above, the target cell can be aware in advance that the cell switch complete message and the CSI report will be transmitted together while being multiplexed within the PUSCH based on Alt. 1 or Alt. 2, and thus perform decoding based on this.

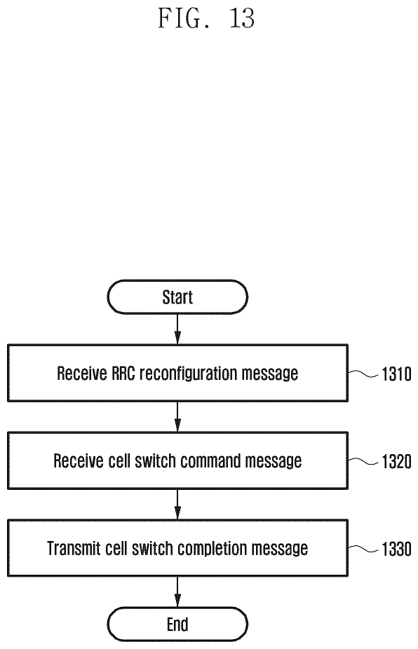

FIG. 13 is a diagram illustrating operations of a UE according to an embodiment of the disclosure.

Referring to FIG. 13, in operation 1310, the UE may receive an RRC reconfiguration message from a source cell. The RRC reconfiguration message may include an LTM candidate configuration including information on candidate target cells. The RRC reconfiguration message received by the UE may include configuration information for CSI measurement and report of the candidate target cell. The configuration information for CSI measurement and report may include, for example, a CSI-RS resource configuration for the candidate target cell and/or a CSI report configuration for the candidate target cell.

In operation 1320, the UE may receive a cell switch command message from the source cell. The cell switch command message may be received via MAC CE. According to an embodiment, the MAC CE for the cell switch command message may include information for indicating whether the UE will report CSI to a target cell. According to an embodiment, the MAC CE for the cell switch command message may include a field for indicating a CSI-RS resource or a CSI-RS resource set to indicate for which CSI-RS resource the UE will report an estimated CSI. When the UE is instructed to report the CSI for the target cell via the cell switch command message, the UE may acquire the CSI for the target cell, based on the CSI-RS resource configuration and/or CSI report configuration for the target cell received via the RRC reconfiguration message, and/or the CSI-RS resource or CSI-RS resource set configuration received via the MAC CE.

In operation 1330, the UE may transmit a cell switch completion message to the target cell. When transmitting the cell switch completion message to the target cell, the UE may transmit a CSI report including the CSI acquired for the target cell together.

FIG. 13 is a flowchart exemplarily showing the operations of the UE performing various embodiments of the disclosure.

Even if not specifically illustrated or described in FIG. 13, the UE may perform its operations for performing various embodiments of the disclosure described above. In addition, even if not specifically illustrated or described in FIG. 13, the UE can perform any UE operations described through FIGS. 1 to 12.

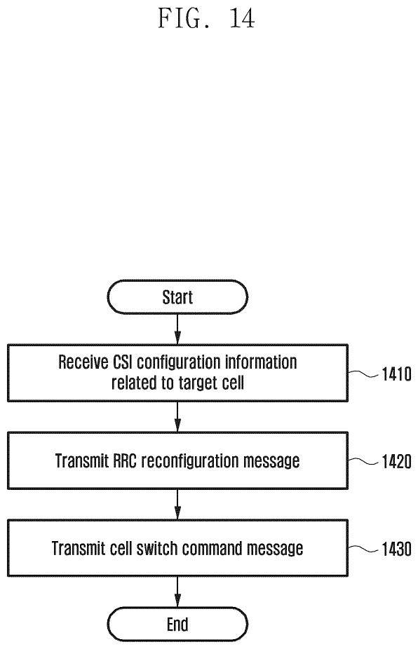

FIG. 14 is a diagram illustrating operations of a base station associated with a source cell according to an embodiment of the disclosure.

Hereinafter, the operations of the base station associated with the source cell is described as the operations of the source cell.

Referring to FIG. 14, in operation 1410, the source cell may receive CSI configuration information related to a target cell from a candidate target cell. The target cell-related CSI configuration information is information used by a UE to acquire CSI for the candidate target cell, and may include a CSI-RS resource configuration for the candidate target cell and/or a CSI report configuration for the candidate target cell.

In operation 1420, the source cell may transmit an RRC reconfiguration message to the UE. The RRC reconfiguration message may include an LTM candidate configuration including information about the candidate target cells. The LTM candidate configuration may include the target cell-related CSI configuration information received from the candidate target cell previously in operation 1410. For example, the RRC reconfiguration message transmitted by the source cell may include configuration information for CSI measurement and report of the candidate target cell. The configuration information for CSI measurement and report may include, for example, a CSI-RS resource configuration for the candidate target cell and/or a CSI report configuration for the candidate target cell.

In operation 1430, the source cell may transmit a cell switch command message to the UE. The cell switch command message may be transmitted via MAC CE. According to an embodiment, the MAC CE for the cell switch command message may include information for indicating whether the UE will report CSI to a target cell. According to an embodiment, the MAC CE for the cell switch command message may include a field for indicating a CSI-RS resource or a CSI-RS resource set to indicate for which CSI-RS resource the UE will report an estimated CSI.

FIG. 14 is a flowchart exemplarily showing the operations of the source cell performing various embodiments of the disclosure. Even if not specifically illustrated or described in FIG. 14, the source cell may perform its operations for performing various embodiments of the disclosure described above. In addition, even if not specifically illustrated or described in FIG. 14, the source cell may perform any source cell operations described through FIGS. 1 to 12.

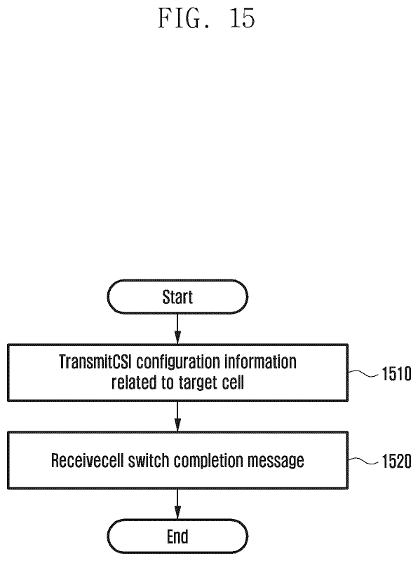

FIG. 15 is a diagram illustrating operations of a base station associated with a target cell according to an embodiment of the disclosure.

Hereinafter, the operations of the base station associated with the target cell is described as the operations of the target cell.

Referring to FIG. 15, in operation 1510, the target cell may transmit CSI configuration information related to the target cell to a source cell. The target cell-related CSI configuration information is information used by a UE to acquire CSI for the target cell, and may include a CSI-RS resource configuration for the target cell and/or a CSI report configuration for the target cell.

In operation 1520, the target cell may receive a cell switch completion message from the UE. The cell switch completion message received from the UE may include a CSI report that contains the CSI pre-acquired by the UE for the target cell. Using the CSI report received together with the cell switch completion message, the target cell may perform fast link adaptation even before the next CSI report is received from the UE.

FIG. 15 is a flowchart exemplarily showing the operations of the target cell performing according to an embodiment of the disclosure. Even if not specifically illustrated or described in FIG. 15, the target cell may perform its operations for performing various embodiments of the disclosure described above. In addition, even if not specifically illustrated or described in FIG. 15, the target cell may perform any target cell operations described through FIGS. 1 to 12.

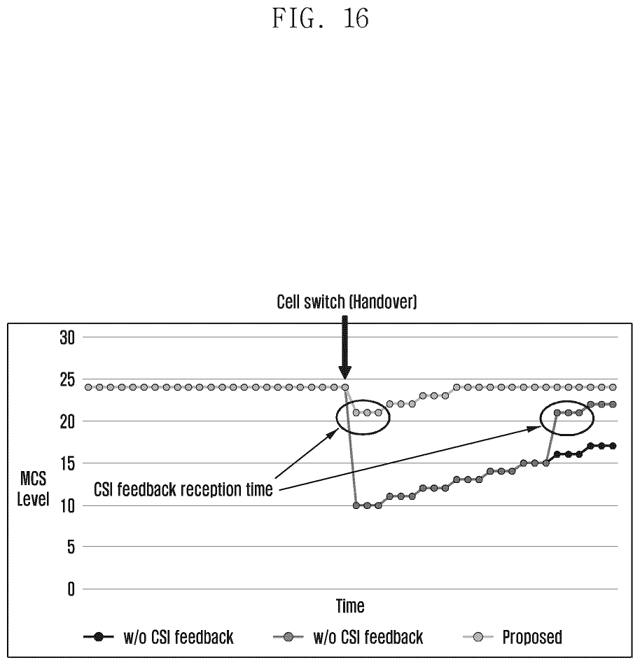

FIG. 16 is a diagram illustrating an MCS level change according to a link adaptation operation and an MCS level change according to a link adaptation operation in a conventional technology according to an embodiment of the disclosure.

In the case of conventional “w/o CSI feedback” in FIG. 16, since there is no CSI for reference immediately after the cell switch, the MCS level starts from the initial MCS level of 10 and gradually increases. In the case of conventional “w/CSI feedback” in FIG. 16, it can be seen that the MCS level gradually increases from the initial MCS level, similar to the “w/o CSI feedback” case, and then, after CSI feedback is received, the MCS level is raised based on CQI information acquired from the corresponding CSI feedback. Compared to conventional “w/o CSI feedback” or “w/CSI feedback”, it can be seen that when the CSI pre-acquisition method according to various embodiments of the disclosure is used, CQI information that the target cell can refer to is transmitted to the target cell simultaneously with the completion of the cell switch, and therefore, a fast link adaptation operation is performed based on the feedback CQI rather than the initial MCS level.

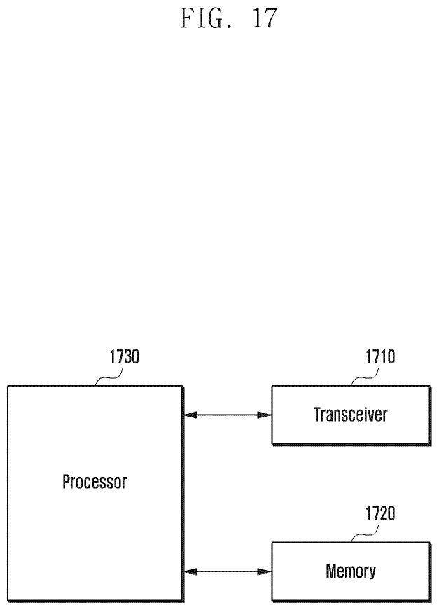

FIG. 17 is a block diagram illustrating an example of components of a UE according to an embodiment of the disclosure.

Referring to FIG. 17, the UE of the disclosure may include a processor 1730, a transceiver 1710, and memory 1720. However, the components of the UE are not limited to the above-described examples. For example, the UE may include more or fewer components than the above-described components. In addition, the processor 1730, the transceiver 1710, and the memory 1720 may be implemented in the form of a single chip.

According to an embodiment, the processor 1730 may control a series of processes in which the UE operates according to the above-described embodiments of the disclosure. For example, the processor 1730 may control the components of the UE to perform the method for pre-acquiring channel state information (CSI) according to embodiments of the disclosure. The processor 1730 may be one or more, and the processor 1730 may perform the above-described CSI pre-acquisition method of the disclosure by executing a program stored in the memory 1720.

The transceiver 1710 may transmit/receive signals with a base station. The signals transmitted to/received from the base station may include control information and data. The transceiver 1710 may be composed of an RF transmitter that up-converts and amplifies the frequency of a signal to be transmitted, an RF receiver that low-noise amplifies a received signal and down-converts the frequency, and the like. This, however, is exemplary, and the components of the transceiver 1710 are not limited to the RF transmitter and the RF receiver. In addition, the transceiver 1710 may receive a signal through a radio channel and output it to the processor 1730, and transmit a signal output from the processor 1730 through a radio channel.

According to an embodiment, the memory 1720 may store programs and data required for the operation of the UE. In addition, the memory 1720 may store control information or data included in signals transmitted/received by the UE. The memory 1720 may be composed of a storage medium or a combination of storage media such as a ROM, a RAM, a hard disk, a CD-ROM, and a DVD. In addition, the memory 1720 may be plural. According to an embodiment, the memory 1720 may store a program for performing the above-described embodiments of the disclosure.

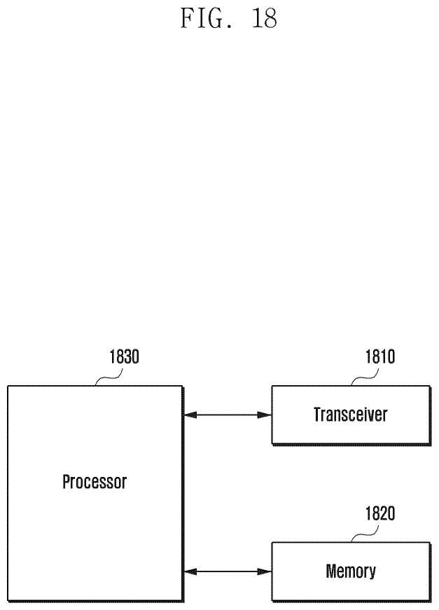

FIG. 18 is a block diagram illustrating an example of components of a base station according to an embodiment of the disclosure.

The components of the base station described in FIG. 18 may be those of a base station associated with a source cell and/or a base station associated with a target cell.

Referring to FIG. 18, the base station of the disclosure may include a processor 1830, a transceiver 1810, and memory 1820. However, the components of the base station are not limited to the above-described examples. For example, the base station may include more or fewer components than the above-described components. In addition, the processor 1830, the transceiver 1810, and the memory 1820 may be implemented in the form of a single chip.

According to an embodiment, the processor 1830 may control a series of processes in which the base station operates according to the above-described embodiments of the disclosure. For example, the processor 1830 may control the components of the base station to perform the method for pre-acquiring channel state information (CSI) according to embodiments of the disclosure. The processor 1830 may be one or more, and the processor 1830 may perform the above-described CSI pre-acquisition method of the disclosure by executing a program stored in the memory 1820.

The transceiver 1810 may transmit/receive signals with a UE. The signals transmitted to/received from the UE may include control information and data. The transceiver 1810 may be composed of an RF transmitter that up-converts and amplifies the frequency of a signal to be transmitted, an RF receiver that low-noise amplifies a received signal and down-converts the frequency, and the like. This, however, is exemplary, and the components of the transceiver 1810 are not limited to the RF transmitter and the RF receiver. In addition, the transceiver 1810 may receive a signal through a radio channel and output it to the processor 1830, and transmit a signal output from the processor 1830 through a radio channel.

According to an embodiment, the memory 1820 may store programs and data required for the operation of the base station. In addition, the memory 1820 may store control information or data included in signals transmitted/received by the base station. The memory 1820 may be composed of a storage medium or a combination of storage media such as a ROM, a RAM, a hard disk, a CD-ROM, and a DVD. In addition, the memory 1820 may be plural. According to an embodiment, the memory 1820 may store a program for performing the above-described embodiments of the disclosure.

The methods according to embodiments described herein may be implemented by hardware, software, or a combination of hardware and software.

When the methods are implemented by software, one or more non-transitory computer-readable storage media storing one or more programs (software modules) including computer-executable instructions may be provided. The computer-executable instructions included in the one or more programs stored in the one or more non-transitory computer-readable storage media may be configured for execution by one or more processors of the electronic device. The computer-executable instructions, when executed by the one or more processors individually or collectively, cause the electronic device to perform the operations of the methods according to various embodiments as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Meanwhile, the embodiments of the disclosure described or illustrated herein are merely provided as specific examples to easily explain the technical content of the disclosure and help understand the disclosure, and are not intended to limit the scope of the disclosure. That is, it is apparent to a person skilled in the art that other modified examples based on the subject matter of the disclosure are possible. In addition, as needed, the above-described embodiments can be combined totally or at least in part.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving, from a base station related to a source cell, a radio resource control (RRC) reconfiguration message including an L1/L2-triggered mobility (LTM) candidate configuration related to a target cell;
receiving, from the base station related to the source cell, a cell switch command message instructing a cell switch to the target cell; and
transmitting, to a base station related to the target cell, a cell switch completion message,
wherein the LTM candidate configuration includes channel state information (CSI) configuration information related to the target cell,
wherein the CSI configuration information related to the target cell includes channel state information reference signal (CSI-RS) resource configuration related to the target cell, and CSI report configuration related to the target cell, and
wherein the cell switch completion message includes CSI for the target cell based on the CSI configuration information related to the target cell.

2. The method of claim 1,
wherein the cell switch command message includes a first field indicating whether the terminal reports the CSI for the target cell, and
wherein the cell switch completion message includes the CSI for the target cell in case that the first field indicates to report the CSI for the target cell.

3. The method of claim 1, wherein the cell switch command message includes a second field indicating a CSI-RS resource for the CSI for the target cell based on the CSI-RS resource configuration related to the target cell.

4. The method of claim 1,
wherein the CSI-RS resource configuration related to the target cell includes information about a non-zero power CSI-RS (NZP CSI-RS), and
wherein the CSI report configuration related to the target cell indicates that the CSI for the target cell includes at least one of a channel quality indicator (CQI), a rank indicator (RI), or a precoding matrix indicator (PMI).

5. A method performed by a base station related to a source cell in a communication system, the method comprising:
receiving, from a base station related to a target cell, channel state information (CSI) configuration information related to the target cell;
transmitting, to a terminal, a radio resource control (RRC) reconfiguration message including an L1/L2-triggered mobility (LTM) candidate configuration; and
transmitting, to the terminal, a cell switch command message instructing a cell switch to the target cell,
wherein the LTM candidate configuration includes the CSI configuration information related to the target cell,
wherein the CSI configuration information related to the target cell includes channel state information reference signal (CSI-RS) resource configuration related to the target cell, and CSI report configuration related to the target cell, and
wherein a cell switch completion message includes CSI for the target cell based on the CSI configuration information related to the target cell.

6. The method of claim 5,
wherein the cell switch command message includes a first field indicating whether the terminal reports the CSI for the target cell, and
wherein the cell switch completion message includes the CSI for the target cell in case that the first field indicates to report the CSI for the target cell.

7. The method of claim 5, wherein the cell switch command message includes a second field indicating a CSI-RS resource for the CSI for the target cell based on the CSI-RS resource configuration related to the target cell.

8. The method of claim 5,
wherein the CSI-RS resource configuration related to the target cell includes information about a non-zero power CSI-RS (NZP CSI-RS), and
wherein the CSI report configuration related to the target cell indicates that the CSI for the target cell includes at least one of a channel quality indicator (CQI), a rank indicator (RI), or a precoding matrix indicator (PMI).

9. A method performed by a base station related to a target cell in a communication system, the method comprising:
transmitting, to a base station related to a source cell, channel state information (CSI) configuration information related to the target cell; and
receiving, from a terminal, a cell switch completion message,
wherein the CSI configuration information related to the target cell includes channel state information reference signal (CSI-RS) resource configuration related to the target cell, and CSI report configuration related to the target cell, and
wherein a cell switch completion message includes CSI for the target cell based on the CSI configuration information related to the target cell.

10. The method of claim 9,
wherein the CSI-RS resource configuration related to the target cell includes information about a non-zero power CSI-RS (NZP CSI-RS), and
wherein the CSI report configuration related to the target cell indicates that the CSI for the target cell includes at least one of a channel quality indicator (CQI), a rank indicator (RI), or a precoding matrix indicator (PMI).

11. A terminal in a communication system, the terminal comprising:
a transceiver;
memory storing one or more computer programs; and
one or more processors communicatively coupled to the transceiver and the memory,
wherein the one or more computer programs include computer-executable instructions that, when executed by the one or more processors individually or collectively, cause the terminal to:
receive, from a base station related to a source cell, a radio resource control (RRC) reconfiguration message including an L1/L2-triggered mobility (LTM) candidate configuration related to a target cell,
receive, from the base station related to the source cell, a cell switch command message instructing a cell switch to the target cell, and
transmit, to a base station related to the target cell, a cell switch completion message,
wherein the LTM candidate configuration includes channel state information (CSI) configuration information related to the target cell,
wherein the CSI configuration information related to the target cell includes channel state information reference signal (CSI-RS) resource configuration related to the target cell, and CSI report configuration related to the target cell, and
wherein the cell switch completion message includes CSI for the target cell based on the CSI configuration information related to the target cell.

12. The terminal of claim 11,
wherein the cell switch command message includes a first field indicating whether the terminal reports the CSI for the target cell, and
wherein the cell switch completion message includes the CSI for the target cell in case that the first field indicates to report the CSI for the target cell.

13. The terminal of claim 11, wherein the cell switch command message includes a second field indicating a CSI-RS resource for the CSI for the target cell based on the CSI-RS resource configuration related to the target cell.

14. The terminal of claim 11,
wherein the CSI-RS resource configuration related to the target cell includes information about a non-zero power CSI-RS (NZP CSI-RS), and
wherein the CSI report configuration related to the target cell indicates that the CSI for the target cell includes at least one of a channel quality indicator (CQI), a rank indicator (RI), or a precoding matrix indicator (PMI).

15. A base station related to a source cell in a communication system, the base station related to the source cell comprising:
a transceiver;
memory storing one or more computer programs; and
one or more processors communicatively coupled to the transceiver and the memory,
wherein the one or more computer programs include computer-executable instructions that, when executed by the one or more processors individually or collectively, cause the base station related to the source cell to:
receive, from a base station related to a target cell, channel state information (CSI) configuration information related to the target cell,
transmit, to a terminal, a radio resource control (RRC) reconfiguration message including an L1/L2-triggered mobility (LTM) candidate configuration, and
transmit, to the terminal, a cell switch command message instructing a cell switch to the target cell,
wherein the LTM candidate configuration includes the CSI configuration information related to the target cell,
wherein the CSI configuration information related to the target cell includes channel state information reference signal (CSI-RS) resource configuration related to the target cell, and CSI report configuration related to the target cell, and
wherein a cell switch completion message includes CSI for the target cell based on the CSI configuration information related to the target cell.

16. The base station related to the source cell of claim 15,
wherein the cell switch command message includes a first field indicating whether the terminal reports the CSI for the target cell, and
wherein the cell switch completion message includes the CSI for the target cell in case that the first field indicates to report the CSI for the target cell.

17. The base station related to the source cell of claim 15, wherein the cell switch command message includes a second field indicating a CSI-RS resource for the CSI for the target cell based on the CSI-RS resource configuration related to the target cell.

18. The base station of related to the source cell claim 15,
wherein the CSI-RS resource configuration related to the target cell includes information about a non-zero power CSI-RS (NZP CSI-RS), and
wherein the CSI report configuration related to the target cell indicates that the CSI for the target cell includes at least one of a channel quality indicator (CQI), a rank indicator (RI), or a precoding matrix indicator (PMI).

19. A base station related to a target cell in a communication system, the base station related to the target cell comprising:
a transceiver;
memory storing one or more computer programs; and
one or more processors communicatively coupled to the transceiver and the memory,
wherein the one or more computer programs include computer-executable instructions that, when executed by the one or more processors individually or collectively, cause the base station related to the target cell to:
transmit, to a base station related to a source cell, channel state information (CSI) configuration information related to the target cell, and
receive, from a terminal, a cell switch completion message,
wherein the CSI configuration information related to the target cell includes channel state information reference signal (CSI-RS) resource configuration related to the target cell, and CSI report configuration related to the target cell, and
wherein a cell switch completion message includes CSI for the target cell based on the CSI configuration information related to the target cell.

20. The base station related to the target cell of claim 19,
wherein the CSI-RS resource configuration related to the target cell includes information about a non-zero power CSI-RS (NZP CSI-RS), and
wherein the CSI report configuration related to the target cell indicates that the CSI for the target cell includes at least one of a channel quality indicator (CQI), a rank indicator (RI), or a precoding matrix indicator (PMI).
